(19) United States
(12) Patent Application Publication
(10) Pub. No.: US 2023/0008259 A1
(43) Pub. Date: Jan. 12, 2023

(54) TECHNIQUES FOR WIDEBAND OPERATION OF SIDELINK COMMUNICATIONS OVER UNLICENSED BAND

(71) Applicant: QUALCOMM Incorporated, San Diego, CA (US)

(72) Inventors: Yisheng XUE, San Diego, CA (US); Xiaoxia ZHANG, San Diego, CA (US); Chih-Hao LIU, San Diego, CA (US); Jing SUN, San Diego, CA (US)

(21) Appl. No.: 17/372,069

(22) Filed: Jul. 9, 2021

(51) Int. Cl. H04W 74/08; H04W 74/00; H04W 72/14; H04W 72/04

(52) U.S. Cl. CPC H04W 74/0816; H04W 74/002; H04W 72/14; H04W 72/0446

(57) ABSTRACT

Some aspects described herein relate to configuring user equipment (UE) for transmitting sidelink communications. A sidelink grant for transmitting sidelink communications over multiple contiguous subchannels across multiple resource block (RB) sets in a slot can be received. A listen-before-talk (LBT) procedure can be performed over the multiple RB sets in the slot. Sidelink communications can be transmitted to one or more other UEs in the multiple contiguous subchannels across at least a subset of the multiple RB sets in the slot for which the LBT procedure succeeds

### BACKGROUND

Aspects of the present disclosure relate generally to wireless communication systems, and more particularly, to performing random access procedures.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable low-latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in 5G communications technology and beyond may be desired.

In some wireless communication technologies, such as 5G, user equipment (UEs) communicate over one or more of multiple interfaces. The multiple interfaces may include a Uu interface between the UE and a base station, where the UE can receive communications from the base station over a downlink and transmit communications to the base station over an uplink. In addition, the multiple interfaces may include a sidelink interface to communicate with one or more other UEs directly over a sidelink channel (e.g., without traversing the base station). Sidelink communications can be extended to unlicensed bands, which may provide additional bandwidth for improved communications. Some unlicensed bands can use listen-before-talk (LBT) procedures to ensure clear channel access when utilizing the unlicensed band for communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, a memory configured to store instructions, and one or more processors communicatively coupled with the memory and the transceiver. The one or more processors are configured to execute the instructions to cause the apparatus to receive, from a base station, a sidelink grant for transmitting sidelink communications over multiple contiguous subchannels across multiple resource block (RB) sets in a slot, perform a listen-before-talk (LBT) procedure over the multiple RB sets in the slot, and transmit, to one or more other UEs, sidelink communications in the multiple contiguous subchannels across at least a subset of the multiple RB sets in the slot for which the LBT procedure succeeds.

In another aspect, an apparatus for wireless communication is provided that includes a transceiver, a memory configured to store instructions, and one or more processors communicatively coupled with the memory and the transceiver. The one or more processors are configured to execute the instructions to cause the apparatus to receive, by the UE, sidelink communications from a transmitting UE in multiple contiguous subchannels across multiple RB sets in a slot for which a LBT procedure succeeds for the transmitting UE, decode sidelink control information in one of the contiguous subchannels present in each of the multiple RB sets to determine whether a sidelink data channel is intended for the UE, and decode, where the sidelink control information indicates that the sidelink data channel is intended for the UE, the sidelink data channel in one or more of the contiguous subchannels in one or more of the multiple RB sets.

In another aspect, a method for wireless communications by a UE is provided that includes receiving, by the UE and from a base station, a sidelink grant for transmitting sidelink communications over multiple contiguous subchannels across multiple RB sets in a slot, performing, by the UE, a LBT procedure over the multiple RB sets in the slot, and transmitting, by the UE and to one or more other UEs, sidelink communications in the multiple contiguous subchannels across at least a subset of the multiple RB sets in the slot for which the LBT procedure succeeds.

In a another aspect, a method for wireless communications by UE is provided that includes receiving, by the UE, sidelink communications from a transmitting UE in multiple contiguous subchannels across multiple RB sets in a slot for which a LBT procedure succeeds for the transmitting UE, decoding sidelink control information in one of the contiguous subchannels present in each of the multiple RB sets to determine whether a sidelink data channel is intended for the UE, and decoding, where the sidelink control information indicates that the sidelink data channel is intended for the UE, the sidelink data channel in one or more of the contiguous subchannels in one or more of the multiple RB sets.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a block diagram illustrating an example of a user equipment (UE), in accordance with various aspects of the present disclosure;

FIG. 3 is a block diagram illustrating an example of a base station, in accordance with various aspects of the present disclosure;

FIG. 4 is a flow chart illustrating an example of a method for transmitting sidelink (SL) communications over a wideband resource allocation that includes multiple resource block (RB) sets, in accordance with various aspects of the present disclosure;

FIG. 5 is a flow chart illustrating an example of a method for decoding SL communications received over a wideband resource allocation that includes multiple RB sets, in accordance with various aspects of the present disclosure;

FIG. 6 is a flow chart illustrating an example of a method for transmitting SL communications over a wideband resource allocation that includes multiple RB sets and intra-cell guard bands, in accordance with various aspects of the present disclosure;

FIG. 7 is a flow chart illustrating an example of a method for transmitting SL grants for a UE, including a SL grant for retransmissions, in accordance with various aspects of the present disclosure;

FIG. 8 illustrates an example of a resource allocation of RB sets, in accordance with various aspects of the present disclosure;

FIG. 9 illustrates an example of a resource allocation having separate reservations for retransmission resources, in accordance with various aspects of the present disclosure;

FIG. 10 illustrates an example of a resource allocation having a common reservation for retransmission resources, in accordance with various aspects of the present disclosure;

FIG. 11 illustrates an example of a resource allocation RB sets are allocated for SL communications, in accordance with various aspects of the present disclosure;

FIG. 12 illustrates an example of a resource allocation for SL communications of frequency division multiplexed (FDMed) code block group (CBG) transmissions, in accordance with various aspects of the present disclosure;

FIG. 13 illustrates an example of a resource allocation for SL communications of FDMed CBG transmissions with a flushing indicator, in accordance with various aspects of the present disclosure;

FIG. 14 illustrates an example of a resource allocation where intra-cell guard bands can be punctured for SL communications, in accordance with various aspects of the present disclosure; and

FIG. 15 is a block diagram illustrating an example of a MIMO communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to sidelink (SL) communications in unlicensed bands. For example, SL communications can refer to device-to-device (D2D) communication among devices (e.g., user equipment (UEs)) in a wireless network. In a specific example, SL communications can be defined for vehicle-based communications, such as vehicle-to-vehicle (V2V) communications, vehicle-to-infrastructure (V2I) communications (e.g., from a vehicle-based communication device to road infrastructure nodes), vehicle-to-network (V2N) communications (e.g., from a vehicle-based communication device to one or more network nodes, such as a base station), a combination thereof and/or with other devices, which can be collectively referred to as vehicle-to-anything (V2X) communications. In V2X communications, vehicle-based communication devices can communicate with one another and/or with infrastructure devices over a SL channel.

Continued support and implementation of V2X communications is provided in fifth generation (5G) new radio (NR) communication technologies, as well as long term evolution (LTE), generally for exchanging safety related messages that are periodic and of relatively small packet-size. In 5G NR, SL resources are allocated using either Mode 1 for in-coverage deployment where a transmitting UE receives a grant from a gNB for channel access or Mode 2 for autonomous deployment where a transmitting UE uses sensing to perform distributed channel access. Each SL channel access can include coupled physical SL control channel (PSCCH) and physical SL shared channel (PSSCH), occupying at least one subchannel, and carrying one transport block (TB). PSCCH can include stage-one SL control information (SCI), which indicates the radio resources of current PSSCH and reserved PSSCH(s), as well as modulation and coding scheme (MCS), beta offset, demodulation reference signal (DMRS), etc. for PSSCH decoding. The stage-two SCI can be piggybacked in PSSCH, which further indicates layer 1 (L1) source identifier (ID), L1 destination ID, and how SL HARQ process is configured for the TB. To carry a jumbo TB, PSSCH can occupy multiple subchannels.

In aspects described herein, SL communications can be extended to unlicensed bands for improved communication throughput, where the unlicensed bands may use (e.g., or impose for coexistence with other radio access technologies) listen-before-talk (LBT) to be performed to ensure clear channel access (CCA) before transmitting communications over the unlicensed band. For example, there can be about 1.8 gigahertz (GHz) in the 5 GHz/6 GHz unlicensed band, and about 7 GHz in the 60 GHz unlicensed band that may be used. Such wide bandwidth can be used to support totally different use cases/deployment scenarios using SL communications. Traffic bursts may be allowed over unlicensed bands, which can include enhanced mobile broadband (eMBB) bursts that can use higher spectral efficiency than typical SL. Specifically, a SL transmitting UE may want to transmit a burst of jumbo TBs over a few subchannels occupying a relatively wider bandwidth (e.g., greater than 20 MHz) upon the arrival of a long traffic burst. Though aspects are generally described herein in terms of D2D/V2X communications, the concepts and techniques can be similarly applied more generally to substantially any type of wireless communications.

In an example, NR allows for wider carriers (up to 100 megahertz (MHz) with 30 kilohertz (kHz) subcarrier spacing (SCS)), and in unlicensed bands, NR can use wideband operation when a carrier can include multiple LBT bandwidths (e.g., 20 MHz in the 5 GHz/6 GHz unlicensed band). Specifically, NR supports punctured transmission in downlink with the specification of intra-cell guard band within two contiguous LBT subbands. In this example, gNB can independently transmit physical downlink shared channels (PDSCHs) over respective resource block (RB)-sets according to LBT outcome when respecting intra-cell guard bands in scheduling. For example, a RB set can include a set of RBs that are contiguous in frequency. An RB, as defined in 5G NR, can include a collection of frequency subcarriers (e.g., 12 subcarriers).

In SL Mode 1, a NR SL UE can receive a grant from gNB for SL transmission. The grant can be issued according to a report from the UE (e.g., a buffer status report (BSR)). The gNB may issue a grant including a considerable number of subchannels across multiple RB sets (e.g., where the UE reports an almost-full buffer after arrival of a long eMBB-like burst). The gNB can alternatively issue multiple grants within respective RB sets, which, however, may challenge physical downlink control channel (PDCCH) capacity. After SL TX (and optional hybrid automatic repeat/request (HARQ) feedback reception over physical sidelink feedback channel (PSFCH)), the transmitting UE can send a PUCCH to gNB to request resources for retransmission by reporting a negative-acknowledgement (NACK).

Aspects described herein relate to allowing SL UEs to perform punctured transmission over multiple RB sets, which may be according to LBT outcome for one or more of the multiple RB sets. The RB sets may have an associated guard band between RB sets, and in one aspect, SL UEs may also puncture the guard band in transmitting over the RB sets. In an aspect, in SL Mode 1, a SL transmitting UE can receive, in downlink control information (DCI) from a gNB, an allocation of multiple RB sets within a slot for transmitting SL communications. The SL transmitting UE can transmit one or more TBs over one or more RB sets, where each TB can be carried by a pair of PSCCH and PSSCH occupying subchannels within the same RB set. In an aspect, the multiple TBs can be towards different receiving UEs or the same receiving UE. The one or more RB sets can be determined based on the outcome of LBT. In addition, in some aspects, retransmission resources for the multiple RB sets can be indicated in the DCI. In an aspect, the SL transmitting UE can indicate retransmission resources for the one or more RB sets in SCI for each RB set or a common set of retransmission resources in the SCI for all of the one or more RB sets.

In another aspect, the SL transmitting UE can perform frequency division multiplexed (FDM) code block group (CBG) transmission over the allocated RB sets (e.g., and based on LBT outcome) with each CBG transmitted over subchannels in the same RB set. In this aspect, the UE can include distributed SCI (dSCI) in each RB set to handle uncertainty related to performing LBT for each RB set. In another aspect, a multi-bit CBG flushing indicator (CBGFI) may be included in the dSCI to distinguish CBG transmission that failed due to LBT from CBG transmission that failed due to other considerations (e.g., cyclic redundancy check (CRC) failure).

The aspects described herein can allow for extending bandwidth for SL communications by using unlicensed bands that can have more bandwidth than other licensed bands in NR. The unlicensed bands can use (or impose or require) LBT operations to ensure CCA when transmitting communications over the unlicensed bands (e.g., to prevent interference with other radio access technologies). Aspects described herein can allow for handling different LBT outcomes for each of multiple RB sets over the unlicensed band to comply with LBT while maximizing available RB sets in the unlicensed band for usage with SL communications. This can allow for improved communication throughput for SL communications by using the larger bandwidths, which can improve communication speed and user experience for SL UEs. In addition, other devices using other radio access technologies in the unlicensed band can remain undistributed by proper usage of LBT.

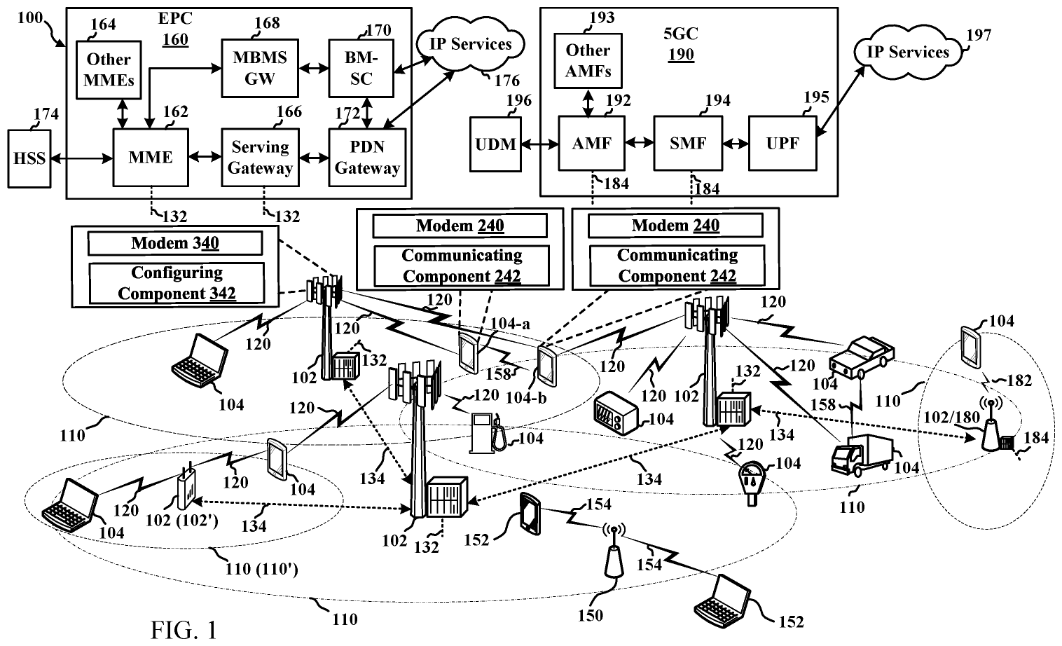

The described features will be presented in more detail below with reference to FIGS. 1-15.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 240 and communicating component 242 for transmitting or receiving sidelink communications in wideband allocation that include multiple RB sets, as described further herein. In addition, some nodes may have a modem 340 and configuring component 342 for configuring UEs with sidelink resource allocation that includes the multiple RB sets, as described herein. Though UEs 104-a and 104-b is shown as having the modem 240 and communicating component 242 and a base station 102 is shown as having the modem 340 and configuring component 342, this is one illustrative example, and substantially any node or type of node may include a modem 240 and communicating component 242 and/or a modem 340 and configuring component 342 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs (e.g., UE 104-a and 104-b) may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network. In addition, in this regard, UEs 104-a, 104-b can use a portion of frequency in the 5 GHz unlicensed frequency spectrum in communicating with the small cell 102′, with other cells, with one another using sidelink communications, etc. The UEs 104-a, 104-b, small cell 102′, other cells, etc. can use other unlicensed frequency spectrums as well, such as a portion of frequency in the 60 GHz unlicensed frequency spectrum.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a positioning system (e.g., satellite, terrestrial), a multimedia device, a video device, a digital audio player (e.g., MP3 player), a camera, a game console, a tablet, a smart device, robots, drones, an industrial/manufacturing device, a wearable device (e.g., a smart watch, smart clothing, smart glasses, virtual reality goggles, a smart wristband, smart jewelry (e.g., a smart ring, a smart bracelet)), a vehicle/a vehicular device, a meter (e.g., parking meter, electric meter, gas meter, water meter, flow meter), a gas pump, a large or small kitchen appliance, a medical/healthcare device, an implant, a sensor/actuator, a display, or any other similar functioning device. Some of the UEs 104 may be referred to as IoT devices (e.g., meters, pumps, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, UE 104-a can be a transmitting SL UE that receives a resource allocation from a base station 102 for communicating with UE 104-b, which can be a receiving SL UE, e.g., in SL Mode 1. Configuring component 342 can configure the UE 104-a for transmitting SL communications in wideband resources including multiple RB sets in a slot. In this example, communicating component 242 can transmit multiple TBs or multiple CBGs over each of the multiple RB sets, which may include generating associated SCI for the TBs or CBGs. Each RB sets can include multiple contiguous subchannels, each of which can include a PSCCH and/or PSSCH. The TBs or CBGs may be toward the same or different receiving UE 104-b. In this regard, for example, communicating component 242 of a receiving UE 104-b can detect SCI in one or more of the RB sets (e.g., in PSCCH) and can accordingly receive and/or process associated data (e.g., in the PSSCH).

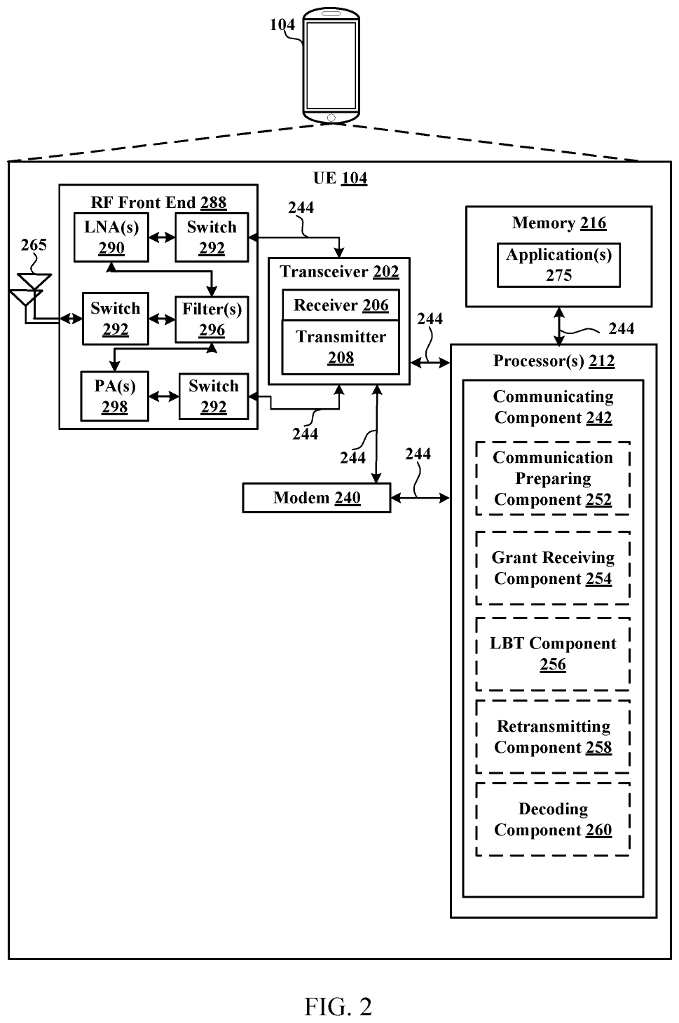

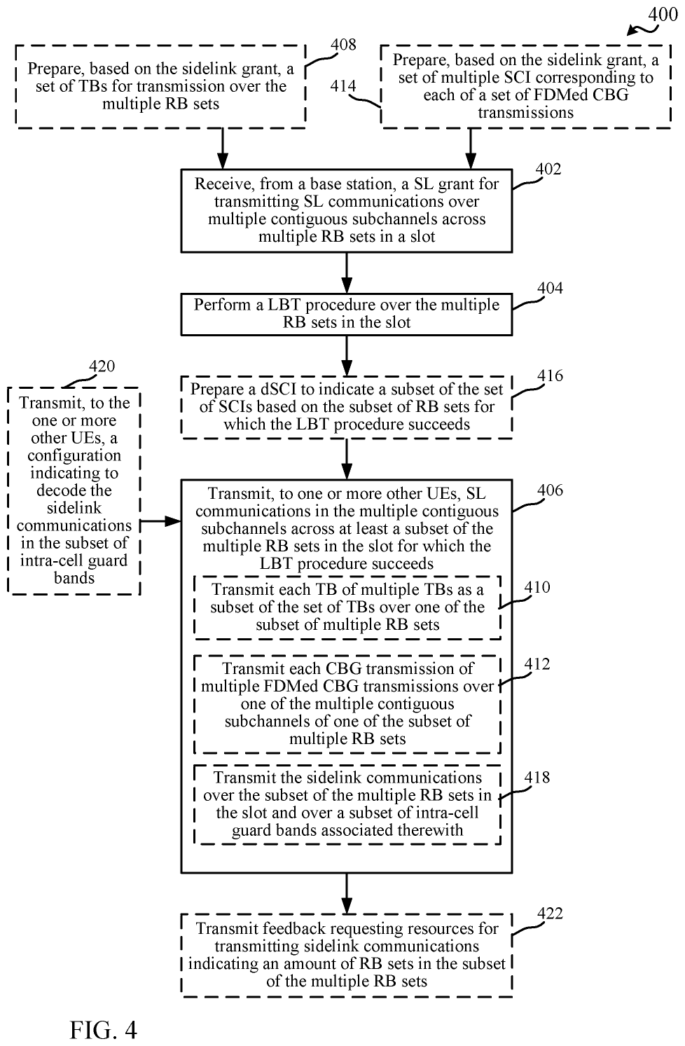

Turning now to FIGS. 2-15, aspects are depicted with reference to one or more components and one or more methods that may perform the actions or operations described herein, where aspects in dashed line may be optional. Although the operations described below in FIGS. 4-7 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 2, one example of an implementation of UE 104 may include a variety of components, some of which have already been described above and are described further herein, including components such as one or more processors 212 and memory 216 and transceiver 202 in communication via one or more buses 244, which may operate in conjunction with modem 240 and/or communicating component 242 for transmitting or receiving sidelink communications in wideband allocation that include multiple RB sets, as described herein.

In an aspect, the one or more processors 212 can include a modem 240 and/or can be part of the modem 240 that uses one or more modem processors. Thus, the various functions related to communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with communicating component 242 may be performed by transceiver 202.

Also, memory 216 may be configured to store data used herein and/or local versions of applications 275 or communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining communicating component 242 and/or one or more of its subcomponents, and/or data associated therewith, when UE 104 is operating at least one processor 212 to execute communicating component 242 and/or one or more of its subcomponents.

Transceiver 202 may include at least one receiver 206 and at least one transmitter 208. Receiver 206 may include hardware and/or software executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102 or a transmitting SL UE. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware and/or software executable by a processor for transmitting data, the code comprising instructions and being stored in a memory (e.g., computer-readable medium). A suitable example of transmitter 208 may including, but is not limited to, an RF transmitter.

Moreover, in an aspect, UE 104 may include RF front end 288, which may operate in communication with one or more antennas 265 and transceiver 202 for receiving and transmitting radio transmissions, for example, receiving wireless communications transmitted by at least one base station 102 or a transmitting SL UE, transmitting wireless communications to at least one base station 102 or a receiving SL UE, etc. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102, one or more other UEs in SL communications, etc. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, communicating component 242 can optionally include a communication preparing component 252 for preparing TBs, CBGs, corresponding SCI, etc. for transmitting over a sidelink, a grant receiving component 254 for receiving a sidelink grant of resources from a base station, which may include a wideband allocation of multiple RB sets, a LBT component 256 for performing a LBT over resources related to each of the multiple RB sets, a retransmitting component 258 for retransmitting sidelink communications in indicated resources, and/or a decoding component 260 for decoding sidelink communications received from a transmitting SL UE, as described herein.

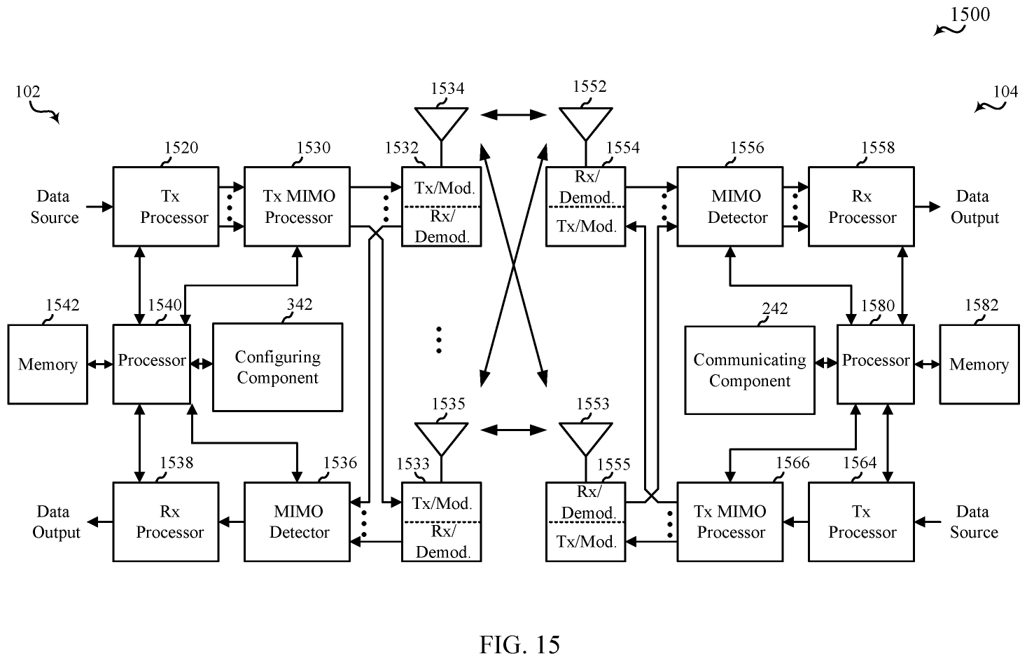

In an aspect, the processor(s) 212 may correspond to one or more of the processors described in connection with the UE in FIG. 15. Similarly, the memory 216 may correspond to the memory described in connection with the UE in FIG. 15.

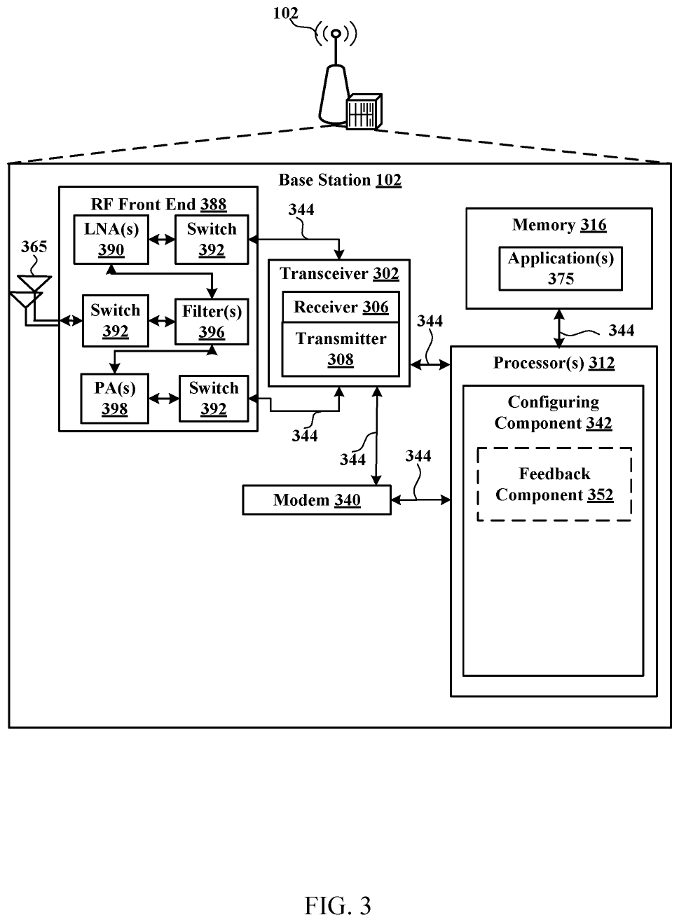

Referring to FIG. 3, one example of an implementation of base station 102 (e.g., a base station 102 and/or gNB 180, as described above) may include a variety of components, some of which have already been described above, but including components such as one or more processors 312 and memory 316 and transceiver 302 in communication via one or more buses 344, which may operate in conjunction with modem 340 and configuring component 342 for configuring UEs with sidelink resource allocation that includes the multiple RB sets, as described herein.

The transceiver 302, receiver 306, transmitter 308, one or more processors 312, memory 316, applications 375, buses 344, RF front end 388, LNAs 390, switches 392, filters 396, PAs 398, and one or more antennas 365 may be the same as or similar to the corresponding components of UE 104, as described above, but configured or otherwise programmed for base station operations as opposed to UE operations.

In an aspect, configuring component 342 can optionally include a feedback component 352 for receiving and processing feedback related to a number of RB sets for which a LBT procedure succeeded or failed, as described herein.

In an aspect, the processor(s) 312 may correspond to one or more of the processors described in connection with the base station in FIG. 15. Similarly, the memory 316 may correspond to the memory described in connection with the base station in FIG. 15.

FIG. 4 illustrates a flow chart of an example of a method 400 for transmitting SL communications over a wideband resource allocation that includes multiple RB sets. In an example, a UE (e.g., UE 104-a, as a SL transmitting UE in sidelink communications) can perform the functions described in method 400 using one or more of the components described in FIGS. 1 and 2.

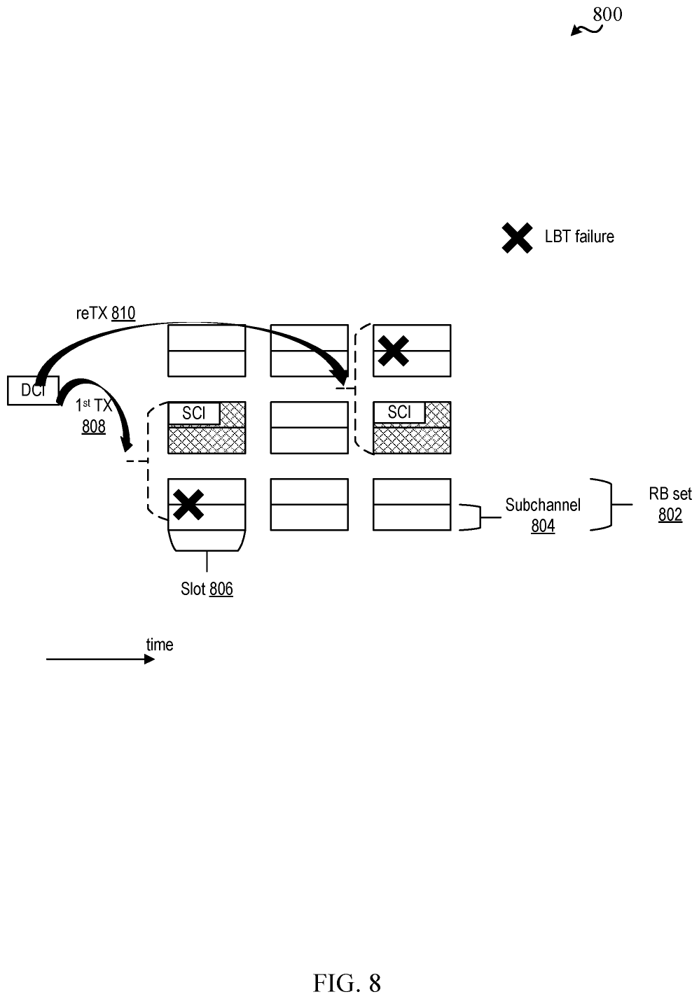

In method 400, at Block 402 (e.g., for transmitting SL UE 104-a), a SL grant for transmitting SL communications over multiple contiguous subchannels across multiple RB sets in a slot can be received from a base station. In an aspect, grant receiving component 254, e.g., in conjunction with processor(s) 212, memory 216, transceiver 202, communicating component 242, etc., can receive, from the base station, the SL grant for transmitting SL communications over multiple contiguous subchannels across multiple RB sets in the slot. In one example, communicating component 242 can request the SL grant or otherwise indicate parameters related to SL transmissions at the transmitting SL UE 104-a, such as a BSR, and may receive the SL grant in response. For example, the SL grant can indicate or specify the multiple RB sets in the slot over which SL communications can be transmitted by the SL UE 104. Each RB set can include multiple contiguous subchannels. In an example, the RB sets can be contiguous or non-contiguous in frequency, and/or can have intra-cell guard band between the RB sets. An example is shown in FIG. 8.

FIG. 8 illustrates an example of a resource allocation 800 of RB sets 802, which can be contiguous or non-contiguous in frequency and/or may have an intra-cell guard band separating the RB sets. Each RB set 802 can include multiple subchannels 804. A SL grant can include multiple RB sets 802, as described above and further herein.

In method 400, at Block 404 (e.g., for transmitting SL UE 104-a), an LBT procedure can be performed over the multiple RB sets in the slot. In an aspect, LBT component 256, e.g., in conjunction with processor(s) 212, memory 216, transceiver 202, communicating component 242, etc., can perform the LBT procedure over the multiple RB sets in the slot. For example, LBT component 256 can perform the LBT procedure over each of the multiple RB sets to determine which RB sets have a clear channel for transmitting SL communications to one or more receiving SL UEs. For example, the LBT procedure can include listening on an RB set (or on a corresponding channel) for transmissions by other devices, which may include devices using other radio access technologies. In any case, LBT component 256 can perform the LBT for multiple RB sets to determine which RB sets are clear for SL transmission by the transmitting SL UE 104-a.

In method 400, at Block 406 (e.g., for transmitting SL UE 104-a), SL communications can be transmitted, to one or more other UEs, in the multiple contiguous subchannels across at least a subset of the multiple RB sets in the slot for which the LBT procedure succeeds. In an aspect, communicating component 242, e.g., in conjunction with processor(s) 212, memory 216, transceiver 202, etc., can transmit, to one or more other UEs (e.g., one or more receiving SL UEs 104-b), SL communications in the multiple contiguous subchannels across at least a subset of the multiple RB sets in the slot for which the LBT procedure succeeds. Communicating component 242 may refrain from transmitting SL communicates in one or more of the multiple RB sets for which the LBT procedure fails or otherwise does not succeed, which may indicate that these one or more RB sets are occupied for communications by another device.

In method 400, optionally at Block 408 (e.g., for transmitting SL UE 104-a), a set of TBs for transmission over the multiple RB sets can be prepared based on the SL grant. In an aspect, communication preparing component 252, e.g., in conjunction with processor(s) 212, memory 216, transceiver 202, communicating component 242, etc., can prepare, based on the SL grant, a set of TBs for transmission over the multiple RB sets. In one example, communication preparing component 252 can prepare, based on the SL grant, the set of TBs for transmission over the multiple RB sets. For example, based on the number of RB sets in the SL grant, the corresponding amount of frequency and/or time resources in the RB sets within the slot, etc., communication preparing component 252 can prepare the set of TBs to fill the resources of the RB sets over the slot. Based on the LBT procedure status for the RB sets, however, it may be possible that some RB sets are not usable for transmitting SL communications.

For example, as shown in FIG. 8, DCI from the base station 102 can allocate 3 RB sets in slot 806 for SL communications. The transmitting SL UE can transmit SL communications, including SCI (e.g., PSCCH) and data (e.g., PSSCH) in each RB set, as described above and further herein. This can include an initial transmission 808 in slot 806 and retransmission 810 in a subsequent slot. In this example, LBT may fail over one of the RB sets in the initial transmission 808 in slot 806. In one example, retransmission 810 can include retransmission of one or more SL communications transmitting in the initial transmission 808 or for which LBT failed, as described further herein.

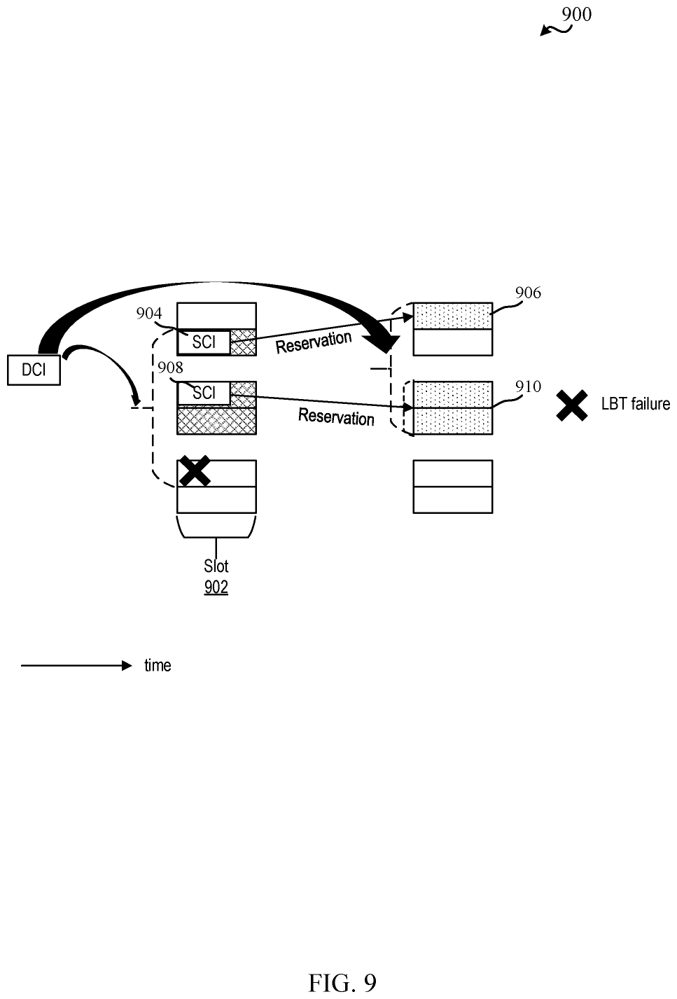

In an example, communication preparing component 252 can prepare the TBs to include the data to be transmitted (e.g., PSSCH) and associated control data (e.g., PSCCH). The associated control data can include SCI, which can indicate resources for retransmitting the data (e.g., PSSCH) in a subsequent slot in case the initial transmission is not successfully received. In one example, communication preparing component 252 can prepare the SCI for each SL transmission (for each PSSCH) to reserve and/or indicate retransmission resources for a given SL transmission in the same frequency resources (e.g., same RB set) in the subsequent slot, or at least to reserve and/or indicate a same number of subchannels for retransmission as the number of subchannels indicated for the initial SL transmission. For example, a PSCCH can include in its reservation field the same number of subchannels, within the retransmission resources granted by gNB, as that it is occupying in current transmission. An example is shown in FIG. 9.

FIG. 9 illustrates an example of a resource allocation 900 having separate reservations for retransmission resources. In resource allocation 900, SCI 904 (e.g., in a PSCCH) for a subchannel having a data channel (e.g. PSSCH) in an RB set of slot 902 can indicate retransmission resources in a subchannel 906 of an RB set in a subsequent slot. In addition, in resource allocation 900, SCI 908 (e.g., in PSCCH) for multiple subchannels of an RB set having a data channel (e.g., PSSCH) in slot 902 can indicate retransmission resources for a same number of subchannels in an RB set 910 of a subsequent slot. For example, the first PSCCH/PSSCH and the second PSCCH/PSSCH point to separate reservations, which can occupy the same number of subchannels as the respective initial transmissions.

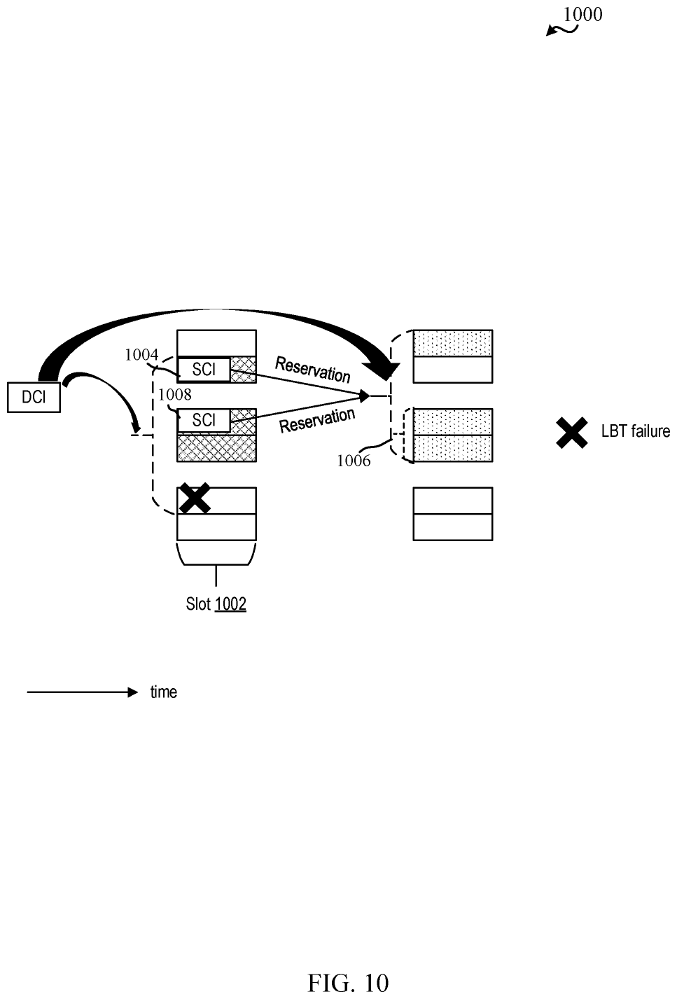

In another example, communication preparing component 252 can prepare SCI for each SL transmission (for each PSSCH) to reserve and/or indicate retransmission resources as all resources indicated for retransmission in the SL grant from the base station 102. For example, where LBT fails in any RB set, some resources granted by the base station 102 for retransmission may not be reserved. As such, the SCI can indicate the whole resources granted by the base station 102 for retransmission, and the receiving SL UE(s) 104-b can discern resources used for retransmission of the initial SL transmission based on this reservation/indication of retransmission resources. An example is shown in FIG. 10.

FIG. 10 illustrates an example of a resource allocation 1000 having a common reservation for retransmission resources. In resource allocation 1000, SCI 1004 (e.g., in a PSCCH) for a subchannel having a data channel (e.g. PSSCH) in an RB set of slot 1002 can indicate a common retransmission resource allocation in multiple RB sets 1006 that can include the same number of RB sets allocated for the initial transmission of SL communications. In addition, in resource allocation 1000, SCI 1008 (e.g., in PSCCH) for multiple subchannels of an RB set having a data channel (e.g., PSSCH) in slot 1002 can indicate the same common retransmission resource allocation in multiple RB sets 1006 in the subsequent slot. For example, as the frequency domain resource allocation (FDRA) of resources for retransmission can be different from that of initial transmission, communicating component 242 can include a scaling factor in the PSSCH transmission to explicitly indicate the FDRA of current PSSCH. This can assist the receiving SL UE in determining the resources for a retransmission of a specific initial transmission from the resources indicated as a whole as reserved for retransmission.

In transmitting the SL communications at Block 406, optionally at Block 410, each TB of multiple TBs, as a subset of the set of TBs, can be transmitted over one of the subset of multiple RB sets. In an aspect, communicating component 242, e.g., in conjunction with processor(s) 212, memory 216, transceiver 202, etc., can transmit each TB of multiple TBs, as a subset of the set of TBs, over one of the subset of multiple RB sets. For example, the transmitting SL UE can have multiple TBs to transmit to different receiving SL UEs 104-b, the same receiving SL UE 104-b, etc. In an example, communicating component 242 can select the multiple TBs as the subset of the set of TBs based on determining which of the multiple RB sets for which the LBT procedure succeeds. As described, for example, communication preparing component 252 can have prepared the set of TBs for transmitting over the multiple RB sets, but LBT may have succeeded only over a subset of the multiple RB sets (which may include less than all of the multiple RB sets). Communicating component 242 can accordingly determine a subset of TBs for transmitting over the subset of the multiple RB sets. In this example, communicating component 242 may refrain from transmitting remaining TBs, which can include holding the remaining TBs until a next SL grant, dropping the remaining TBs, and/or the like.

The set of TBs, as prepared, or the multiple TBs, as transmitted, may each include data to be transmitted (e.g., PSSCH) and associated control data (e.g., PSCCH). In this regard, communicating component 242 can select the multiple TBs to be transmitted to include the data (e.g., PSSCH) and corresponding control data (e.g., PSCCH) in the subset of the multiple RB sets.

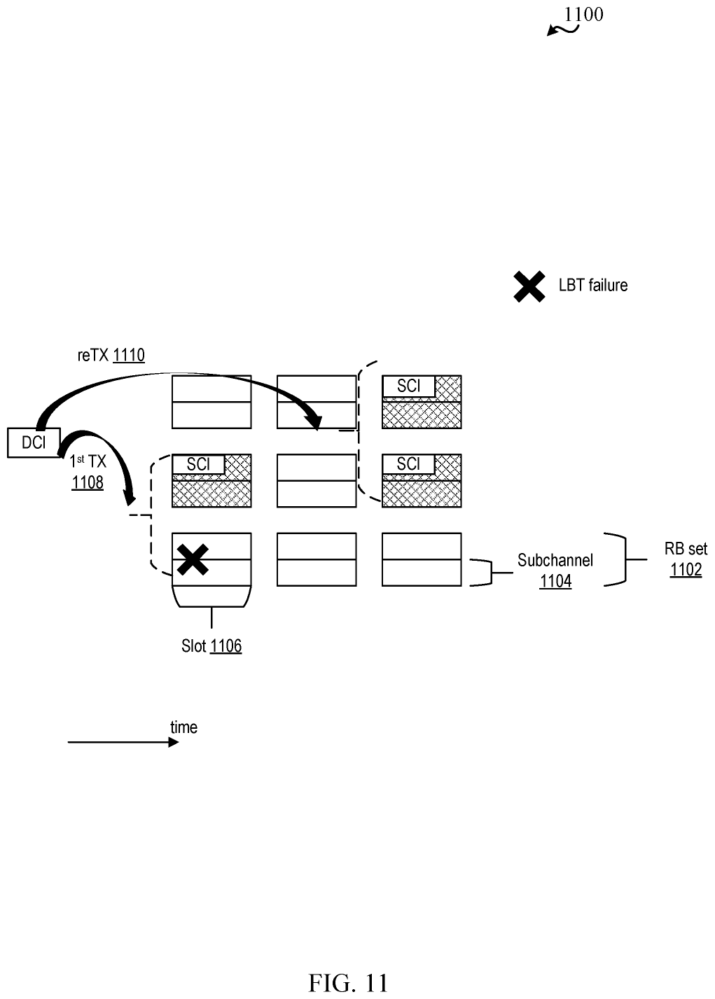

Referring again to FIG. 8, for example, a NR SL UE operating in Mode 1 can perform punctured transmission according to LBT outcome when receiving a grant (either dynamic or configured) from gNB consisting of, per slot, a few of contiguous subchannels 804 across multiple RB sets 802. Specifically, the UE can transmit multiple TBs, each of which is carried by a pair of PSCCH/PSSCH occupying subchannels 804 within the same RB set 802. The multiple TBs can be towards different receiving UEs (like NR-unlicensed (NR-U) downlink), or towards the same receiving UE. A SL UE receiving multiple TBs in the same slot is supported in NR SL Release 16. An example is shown in FIG. 11.

FIG. 11 illustrates an example of a resource allocation 1100 where DCI from the base station 102 can allocate 3 RB sets 1102 in slot 1106 for SL communications. The transmitting SL UE can transmit SL communications, including SCI (e.g., PSCCH) and data (e.g., PSSCH) in each RB set, as described above and further herein. This can include an initial transmission 1108 in slot 1106 and retransmission 1110 in a subsequent slot. In this example, LBT may fail over one of the RB sets in the initial transmission 1108 in slot 1106. In one example, retransmission 1110 can include retransmission of one or more SL communications transmitting in the initial transmission 1108 or for which LBT failed, as described further herein. In resource allocation 1100, the UE can transmit multiple same RB set PSCCH/PSSCHs carrying respective TBs—this may include transmitting one TB per RB set, as shown in FIG. 11. In an example, where the UE is granted four subchannels 1104 across three RB sets 1102 in the slot 1106 in the SL grant, based on LBT outcome, the UE may transmit two pairs of PSCCH/PSSCH carrying two TBs over the two RB sets that pass LBT. A timeline may include the UE beginning to prepare, right after, or otherwise in response to or based on, receiving the SL grant, the multiple (e.g., three in the example of FIG. 11) PSCCH/PSSCHs, each of which can occupy contiguous subchannels within the same RB set (e.g., leaving out the intra-cell guard bands between the RB sets). Upon the LBT outcome, the UE decides which sets of PSCCH/PSSCHs (e.g., the first two in the example of FIG. 11) are to be transmitted.

In another example, the UE can perform FDMed CBG transmission, with one CBG transmitted over subchannel(s) within the same RB set. For example, in transmitting the SL communications at Block 406, optionally at Block 412, each CBG transmission of multiple FDMed CBG transmissions can be transmitted over one of the multiple contiguous subchannels of one of the subset of multiple RB sets. In an aspect, communicating component 242, e.g., in conjunction with processor(s) 212, memory 216, transceiver 202, etc., can transmit each CBG transmission of multiple FDMed CBG transmissions over one of the multiple contiguous subchannels of one of the subset of multiple RB sets. Thus, for example, each RB set, for which LBT succeeds, can include a CBG transmission. For example, the multiple CBGs can correspond to CBG portions of a single transmission (e.g., to one or more receiving SL UEs). It is possible, however, that some of the multiple RB sets, or leading subchannels having SCI for the CBG transmission, may not be received due to LBT failure. Accordingly, for example, communicating component 242 can prepare a dSCI corresponding to the CBGs that are transmitted over the subset of multiple RB sets.

In this regard, in method 400, optionally at Block 414, a set of multiple SCI corresponding to each of a set of FDMed CBG transmissions can be prepared based on the SL grant. In an aspect, communication preparing component 252, e.g., in conjunction with processor(s) 212, memory 216, transceiver 202, communicating component 242, etc., can prepare, based on the sidelink grant, the set of multiple SCI corresponding to each of the set of FDMed CBG transmissions. For example, communication preparing component 252 can prepare the SCI to include control information for each CBG transmission, where the SCI can indicate resources (e.g., a subchannel or other frequency resource, time resource, which may be the same slot, etc.) over which the CBG transmission is to be transmitted based on the SL grant received from the base station 102, MCS, beta offset, DMRS, etc. for each CBG transmission, and/or the like.

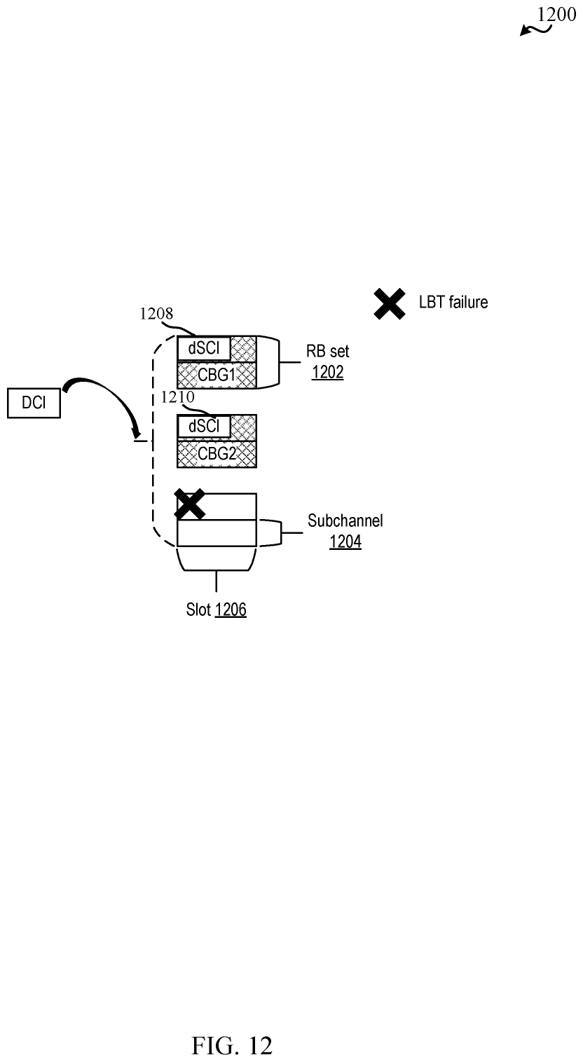

In method 400, optionally at Block 416, a dSCI can be prepared to indicate a subset of the set of SCIs based on the subset of RB sets for which the LBT procedure succeeds. In an aspect, communicating component 242, e.g., in conjunction with processor(s) 212, memory 216, transceiver 202, etc., can prepare the dSCI to indicate (or include) the subset of the set of SCIs based on the subset of RB sets for which the LBT procedure succeeds. For example, the dSCI can be the same for each CBG transmission and can be sent over each RB in the subset of RBs for each FDMed CBG transmission. In another example, the dSCI for each CBG transmission can indicate resources of other dSCIs in other RB sets, such to inform of the resources used for dSCI (e.g., and not for PSSCH data). This can assist a receiving SL UE in determining which CBGs are transmitted in which RB sets, and can ensure that the receiving SL UE receives the proper SCI for the transmitted CBGs that are actually transmitted in the subset of RBs for which LBT succeeds. An example is shown in FIG. 12.

FIG. 12 illustrates an example of a resource allocation 1200 for SL communications of FDMed CBG transmissions. For example, the resource allocation 1200 can include one or more RB sets 1202 each having multiple subchannels 1204 in a slot 1206. The UE can perform FDMed CBG transmission, with one CBG carried by a set of contiguous subchannels 1204 within the same RB set 1202, and transmit dSCIs over respective RB set-wise leading subchannels, such as dSCI 1208 and/or dSCI 1210. At each RB set-wise leading subchannel, the UE can transmit the distributed PSCCH each having the dSCI. In addition, the stage two SCI can also be carried in the set of subchannels within the same RB set (or just within the RB set-wise leading subchannel). Each of these dSCIs 1208, 1210 can indicate that FDMed CBGs are carried over the subchannels across respective RB sets. In one example of a timeline, the dSCIs can be built right after, or in response to or otherwise based on, receiving the SL grant. Then, according to LBT outcome, the UE can decide which set of SCIs and CBGs are to be transmitted. Each dSCI can indicate that, within each RB set, some resources are reserved for the dSCI and, hence may not be used for PSSCH data. In an example, dSCIs can trade more overhead for higher reliability with respect to LBT. After receiving one of the dSCIs, the corresponding receiving SL UE (or other receiving entity) can proceed to decoding of the whole FDMed CBG transmission over the subset of RB sets and can generate corresponding responses towards respective CBGs. Each dSCI can carry the common reservation field.

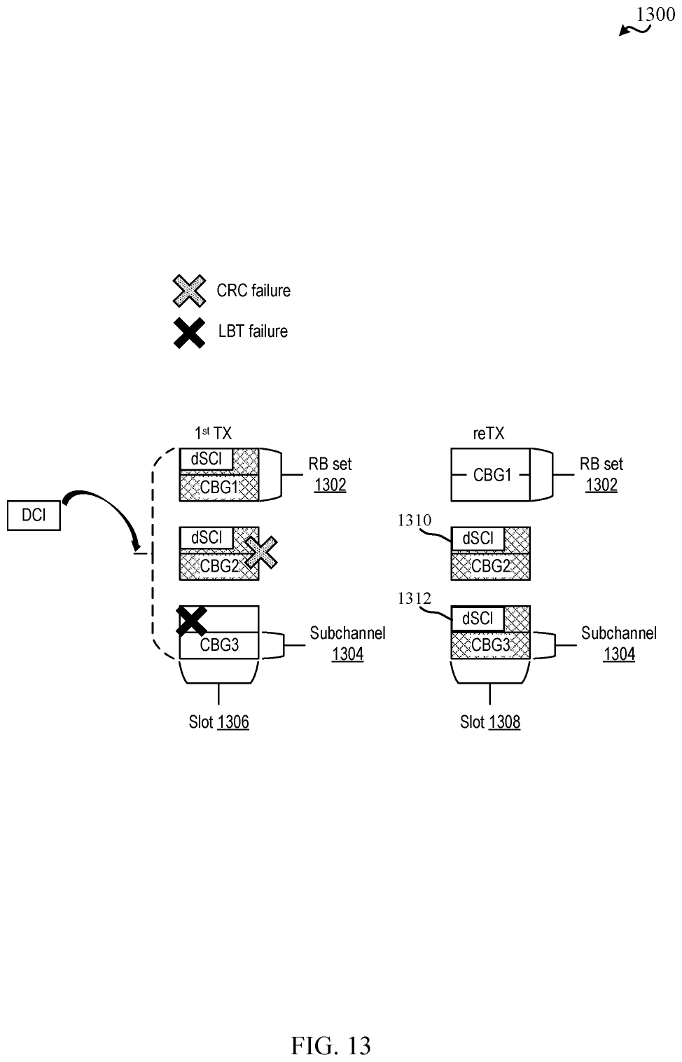

In addition, for example, communicating component 242 can generate the dSCI to include a multi-bit indicator to indicate whether the LBT for each CBG succeeded or not. In one example, the multiple bit indicator can be a flushing indicator (e.g., CBG flushing indicator (CBGFI)) indicating whether to flush CBGs that are not transmitted due to LBT failure. An example is shown in FIG. 10 where the first transmission of CBG 3 is blocked by LBT failure and CBG 2 can result in a CRC failure. In retransmitting the CBG(s), the UE may want to retransmit CBG 2 with combination decoding to improve reliability thereof, but transmit CBG 3 without any combination decoding as the initial transmission was not sent due to LBT failure. In this example, communicating component 242 can set the bit for CBG 3 in the CBGFI to indicate flushing, but not on CBG 2. This multiple bit CBGFI may be useful when either channel occupancy time structure indication (COT-SI) is not specified for SL over unlicensed band, or the transmitting SL UE only receives one slot SL grant for initial TX (and, hence, may not be enough time to send COT-SI). An example is shown in FIG. 13.

FIG. 13 illustrates an example of a resource allocation 1300 for SL communications of FDMed CBG transmissions. For example, the resource allocation 1300 can include one or more RB sets 1302 each having multiple subchannels 1304 in a slot 1306 for an initial transmission, and one or more RB sets 1302 each having multiple subchannels 1304 in a slot 1308 for retransmission. In slot 1306, the initial transmission of CBG2 may fail due to CRC failure, and the initial transmission of CBG3 may fail due to LBT failure. In this example, dSCI 1310 and/or 1312 in the retransmission resources in slot 1308 may include a bitmap indicating which CBGs succeeded or failed LBT, and the receiving SL UE can accordingly determine how to decode the retransmitted CBGs based on whether retransmission is due to LBT failure or not.

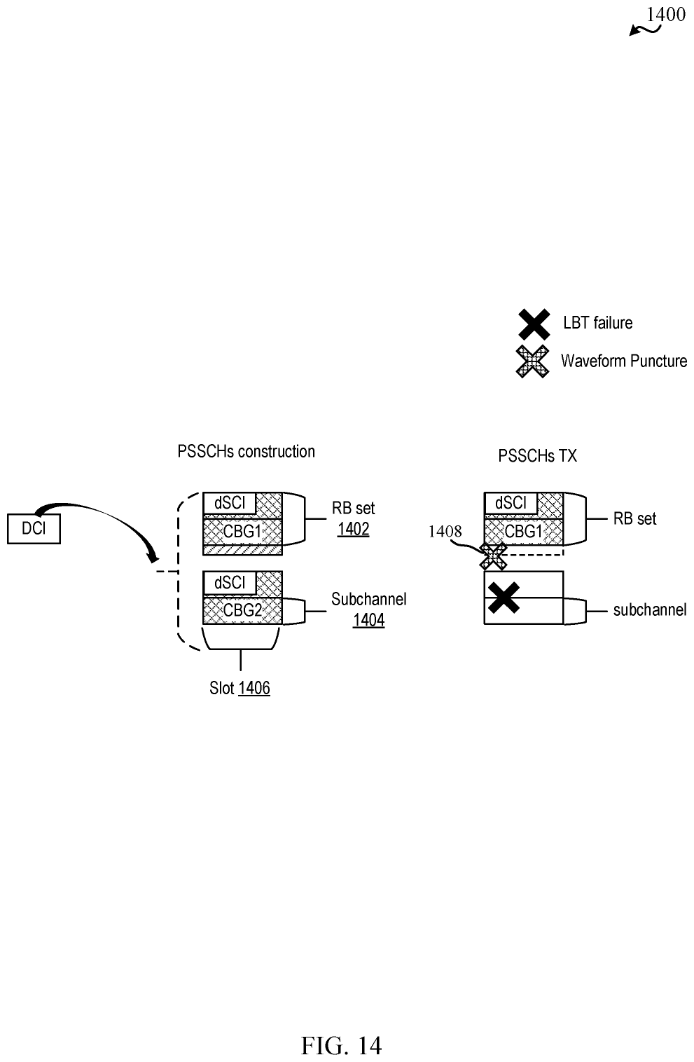

In another example, in transmitting the SL communications at Block 406, optionally at Block 418, the SL communications can be transmitted over the subset of the multiple RB sets in the slot and over a subset of intra-cell guard bands associated therewith. In an aspect, communicating component 242, e.g., in conjunction with processor(s) 212, memory 216, transceiver 202, etc., can transmit the SL communications over the subset of the multiple RB sets in the slot and over the subset of intra-cell guard bands associated therewith. For example, each RB set may have one or more associated intra-cell guard band between it and a next RB set or other frequency division. In some examples, communicating component 242 can determine to utilize the intra-cell guard band for transmitting as well, such as where communicating component 242 is transmitted over RB sets that are near each other (e.g., separated only by the intra-cell guard band) in frequency. An example is shown in FIG. 14.

FIG. 14 illustrates an example of a resource allocation 1400 where intra-cell guard bands can be punctured for SL communications. For example, resource allocation 1400 can include multiple RB sets 1402 having multiple subchannels 1404 in a slot 1406. Based on determining that RB sets having intra-cell guard band are allocated, the transmitting SL UE can determine to also puncture intra-cell guard band 1408 in transmitting the SL communications. In the specific example of resource allocation 1400, the intra-cell guard band can also be punctured though LBT may fail on one of the RB sets 1402.

In this example, where, after receiving the SL grant, the UE can prepare PSSCH(s) including the resources in the intra-cell guard bands. According to LBT outcome, the UE may puncture those waveforms/symbols generated over the intra-cell guard bands to comply with punctured transmission. Based upon decoded SCIs/dSCIs, the receiving SL UE (or other receiving entity) can determine the waveform/symbol punctured by transmitting SL UE according to LBT outcome. This can be useful in cases where either COT-SI is NOT specified for SL over unlicensed band, or where the UE receives a one slot SL grant for TX (and, hence, may not be enough time to send COT-SI).

In an example, where the intra-cell guard bands can be punctured as well, in method 400, optionally at Block 420, a configuration indicating to decode the SL communications in the subset of intra-cell guard bands can be transmitted to the one or more UEs. In an aspect, communicating component 242, e.g., in conjunction with processor(s) 212, memory 216, transceiver 202, etc., can transmit, to the one or more other UEs (e.g., one or more receiving SL UEs 104-b), the configuration indicating to decode the sidelink communications in the subset of intra-cell guard bands. For example, the configuration can be a radio resource control (RRC) or other layer 3 (L3) configuration, or may be configured or activated in SCI or by media access control (MAC) control element (CE), etc. In this example, smart decoding for opportunistic use of intra-cell guard band can be configured in L3 (as a resource-pool wise configuration, or a SL link-wise configuration). To provide further flexibility, the transmitting SL UE can be configured to carry 1-bit in SCI to dynamically indicate whether smart decoding is used for the corresponding PSSCH.

In method 400, optionally at Block 422, feedback requesting resources for transmitting sidelink communications can be transmitted indicating an amount of RB sets in the subset of the multiple RB sets. In an aspect, communicating component 242, e.g., in conjunction with processor(s) 212, memory 216, transceiver 202, etc., can transmit feedback requesting resources for transmitting sidelink communications indicating the amount of RB sets in the subset of the multiple RB sets. For example, communicating component 242 can transmit the feedback to the base station 102 as a multiple bit feedback to indicate a level of RB sets received in the SL grant that were not transmitted due to LBT failure (or may indicating a level of RB sets actually punctured and used for transmitting SL communication). In one example, communicating component 242 can transmit the feedback where each bit value can indicate an amount of RB sets that were not transmitted due to LBT failure, or otherwise an amount of RB sets needed to retransmit SL communications that were not transmitted due to LBT failure, where the amount can be in relation to the amount of RB sets indicated in the initial SL grant (e.g., as received at Block 402). In one specific example, for a 2-bit feedback, each of 4 possible values could indicate 0%, 25%, 50%, or 100% of the amount of RB sets in the initial SL grant are needed for transmission.

In another example, the feedback can include a sufficient number of bits to indicate for each RB set whether LBT succeeded or failed. In any case, the base station 102 can provide the transmitting SL UE 104-a with additional resources for transmitting the SL communications that failed due to failed LBT. In this example, the transmitting SL UE 104-a can be granted PUCCH resources for transmitting the multiple bit feedback to the base station 102, and can transmit the multiple bit feedback to the base station 102 over the resources. The method can again proceed to Block 402 where the transmitting SL UE 104-a receives another SL grant with resources for transmitting the SL communications that failed due to failed LBT.

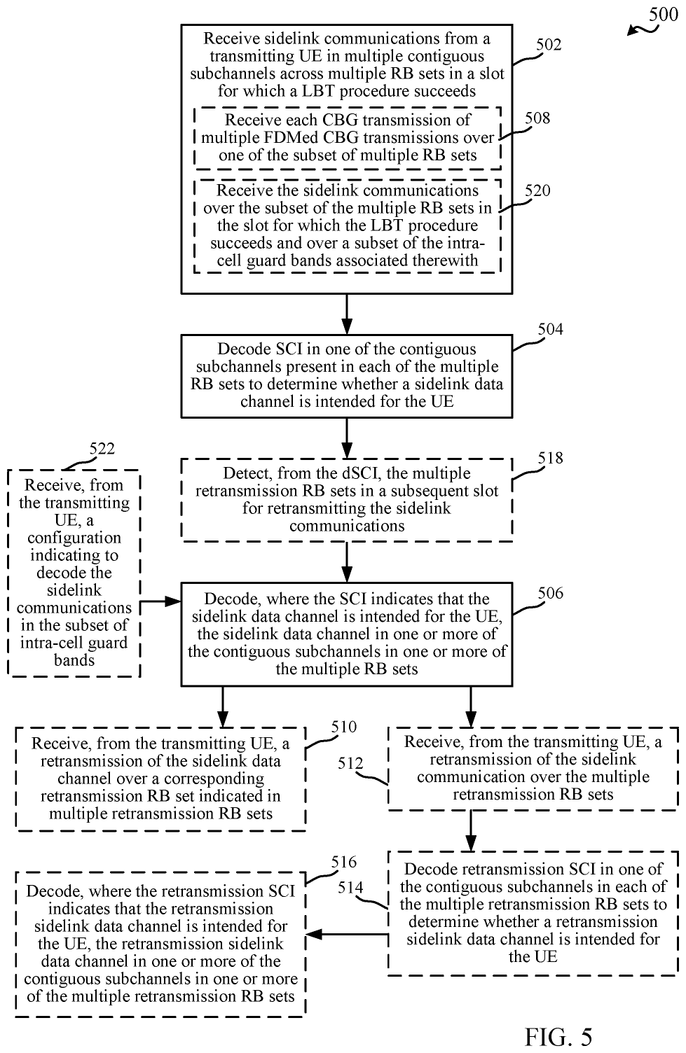

FIG. 5 illustrates a flow chart of an example of a method 500 for decoding SL communications received over a wideband resource allocation that includes multiple RB sets. In an example, a UE (e.g., UE 104-b, as a receiving SL UE in sidelink communications) can perform the functions described in method 500 using one or more of the components described in FIGS. 1 and 2.

In method 500, at Block 502 (e.g., for receiving SL UE 104-b), SL communications can be received from a transmitting UE in multiple contiguous subchannels across multiple RB sets in a slot for which a LBT procedure succeeds. In an aspect, communicating component 242, e.g., in conjunction with processor(s) 212, memory 216, transceiver 202, etc., can receive SL communications from the transmitting UE in the multiple contiguous subchannels across the multiple RB sets in the slot for which the LBT procedure succeeds. In one example, communicating component 242 can receive the SL communications based on monitoring the RB sets for control data (e.g., PSCCH) related to, or indicating parameters for receiving or decoding, corresponding SL data communications in the unlicensed frequency spectrum. As described, for example, the control data may include an indication of resources over which the SL communications are transmitted, MCS, beta offset, DMRS, etc. for the SL communications. In another example, the SL communications may include an identifier related to the receiving SL UE 104-b so the receiving SL UE 104-b can determine that the SL communications are intended for the receiving SL UE 104-b. For example, the receiving SL UE 104-b can be configured (e.g., via layer 3 configuration) to perform blind SCI decoding based on multiple decoding hypotheses throughout a full resource pool over a grid of sub-channel. For example, each sub-channel can be configured over one RB set, and the receiving SL UE 104-b can blindly search for SCI at each RB set. The destination identifier can be in the stage 2 SCI and the receiving SL UE 104-b can determine whether the SL communications are intended for it based on the identifier in the stage 2 SCI.

In method 500, at Block 504 (e.g., for receiving SL UE 104-b), SCI can be decoded in one of the contiguous subchannels present in each of the multiple RB sets to determine whether a SL data channel is intended for the UE. In an aspect, decoding component 260, e.g., in conjunction with processor(s) 212, memory 216, transceiver 202, communicating component 242, etc., can decode SCI in one of the contiguous subchannels present in each of the multiple RB sets to determine whether the SL data channel (e.g., PSSCH) is intended for the UE. As described, in an example, this can include decoding each SCI in each RB set, where the RB sets include different TBs that may or may not be intended for the receiving SL UE. In another example, this may include decoding one dSCI in one RB set, which may provide information for all RB sets or may otherwise provide the location of dSCI in the other RB sets. Where the dSCI provides information of dSCI in the other RB sets, the receiving SL UE may also decode the other dSCI based on this information in determining whether SL data channel communications are intended for the UE.

In method 500, at Block 506 (e.g., for receiving SL UE 104-b), where the SCI indicates that the SL data channel is intended for the UE, the SL data channel can be decoded in one or more of the contiguous subchannels in one or more of the multiple RB sets. In an aspect, decoding component 260, e.g., in conjunction with processor(s) 212, memory 216, transceiver 202, communicating component 242, etc., can decode, where the SCI indicates that the SL data channel is intended for the UE, the SL data channel in one or more of the contiguous subchannels in the one or more of the multiple RB sets. As described, the RB sets may include multiple contiguous subchannels, which may include at least one subchannel having the SCI (e.g., in PSCCH) and another subchannel having at least a portion of the SL data channel (e.g., PSSCH). For example, the RB sets may include one or more TBs intended for the receiving SL UE. In another example, the RB sets may include multiple FDMed CBGs for a transmission intended for the receiving SL UE.

In this example, in receiving the SL communications at Block 502, optionally at Block 508, each CBG transmission of multiple FDMed CBG transmissions can be received over one of the subset of multiple RB sets. In an aspect, communicating component 242, e.g., in conjunction with processor(s) 212, memory 216, transceiver 202, etc., can receive each CBG transmission of the multiple FDMed CBG transmissions over one of the subset of multiple RB sets. In this example, the SCI may include the dSCI corresponding to the multiple CBGs, as described above, and decoding component 260 can decode the multiple CBGs based on the information in the dSCI, which may indicate resources in the RB sets used for dSCI and/or resources in the RB sets used for corresponding SL data communications. Communicating component 242 can accordingly receive the SL data communications over the resources in the RB sets determined as used for the corresponding SL data communications.

In an example, each SL communication received from the transmitting UE may have associated retransmission resources over which the SL communication is retransmitted to ensure the receiving SL UE receives the SL communication. As described above, the retransmission resources can be separately indicated or reserved for each SL communication or may be commonly indicated or reserved for all SL communications from the transmitting SL UE in the RB sets of a slot. Where the retransmission resources are separately indicated or reserved, for example, in method 500, optionally at Block 510, a retransmission of the SL data channel can be received from the transmitting UE over a corresponding retransmission RB set indicated in multiple retransmission RB sets. In an aspect, decoding component 260, e.g., in conjunction with processor(s) 212, memory 216, transceiver 202, communicating component 242, etc., can receive, from the transmitting UE, the retransmission of the SL data channel over the corresponding retransmission RB set indicated in multiple retransmission RB sets. For example, each SCI can separately indicate the retransmission RB set for its corresponding initial SL communication. In this example, decoding component 260 can determine the retransmission RB set for the initial SL communication based on the corresponding SCI and can receive the retransmission in the determined retransmission RB set.

In another example, in method 500, optionally at Block 512, a retransmission of the SL communication can be received from the transmitting UE over the multiple retransmission RB sets. In an aspect, decoding component 260, e.g., in conjunction with processor(s) 212, memory 216, transceiver 202, communicating component 242, etc., can receive, from the transmitting UE, the retransmission of the SL communication over the multiple retransmission subsets. In this example, the SCI can indicate retransmission resources for all of the initial SL communications, which may be the same RB sets used for the initial SL communications but in a different slot, or may be different RB sets, but may include a same number of RB sets as used for the initial SL communications. In any case, the SCI can indicate the retransmission resources for the SL communications.

In this example, in method 500, optionally at Block 514, retransmission SCI can be decoded in one of the contiguous subchannels in each of the multiple retransmission RB sets to determine whether a retransmission SL data channel is intended for the UE. In addition, optionally at Block 516, where the retransmission SCI indicates that the retransmission SL data channel is intended for the UE, the retransmission SL data channel can be decoded in one or more of the contiguous subchannels in one or more of the multiple retransmission RB sets. In an aspect, decoding component 260, e.g., in conjunction with processor(s) 212, memory 216, transceiver 202, communicating component 242, etc., can decode the retransmission SCI in one of the contiguous subchannels in each of the multiple retransmission RB sets to determine whether a retransmission SL data channel is intended for the UE, similarly as described with respect to Block 504. In addition, in an aspect, decoding component 260, e.g., in conjunction with processor(s) 212, memory 216, transceiver 202, communicating component 242, etc., can decode, wherein the retransmission SCI indicates that the retransmission SL data channel is intended for the UE, the retransmission SL data channel in one or more of the contiguous subchannels in one or more of the multiple retransmission RB sets, similarly as described with respect to Block 506.

Where the SL communications include FDMed CBG transmissions in the multiple RB sets, in method 500, optionally at Block 518, the multiple retransmission RB sets in a subsequent slot for retransmitting the SL communications can be detected from dSCI. In an aspect, decoding component 260, e.g., in conjunction with processor(s) 212, memory 216, transceiver 202, communicating component 242, etc., can detect, from dSCI, the multiple retransmission RB sets in the subsequent slot for retransmitting the SL communications. For example, each dSCI can specify the retransmission resources for a corresponding CBG transmission or may specify the retransmission resources for all CBG transmissions. In another example, the dSCI may specify retransmission resources for all CBG transmissions, and decoding component 260 can determine the resources for retransmission of a specific CBG from dSCI transmitted in the retransmission resources, as described above.

In addition, as described, the dSCI may include a multiple bit indicator (e.g., CBGFI) indicating whether LBT succeeded or failed for each CBG transmission to allow the receiving SL UE to distinguish retransmission due to LBT failure from retransmission due to other failure (e.g., failed CRC). For example, the transmitting UE may differently retransmit the SL communication in each case (e.g., with or without combination decoding, as described above).

In receiving the SL communications at Block 502, optionally at Block 520, the SL communications can be received over the subset of the multiple RB sets in the slot for which the LBT procedure succeeds and over a subset of the intra-cell guard bands associated therewith. In an aspect, communicating component 242, e.g., in conjunction with processor(s) 212, memory 216, transceiver 202, etc., can receive the SL communications over the subset of the multiple RB sets in the slot for which the LBT procedure succeeds and over the subset of the intra-cell guard bands associated therewith. As described, for example, each RB set may have one or more associated intra-cell guard band between it and a next RB set or other frequency division. In some examples, communicating component 242 can determine to utilize the intra-cell guard band for receiving as well, such as where communicating component 242 is transmitted over RB sets that are near each other (e.g., separated only by the intra-cell guard band) in frequency.

In an example, where the intra-cell guard bands can be punctured as well, in method 500, optionally at Block 522, a configuration indicating to decode the SL communications in the subset of intra-cell guard bands can be received from the transmitting UE. In an aspect, communicating component 242, e.g., in conjunction with processor(s) 212, memory 216, transceiver 202, etc., can receive, from the transmitting UE, the configuration indicating to decode the sidelink communications in the subset of intra-cell guard bands. For example, as described, the configuration can be a RRC or other L3 configuration, or may be configured or activated in SCI or by MAC-CE, etc.

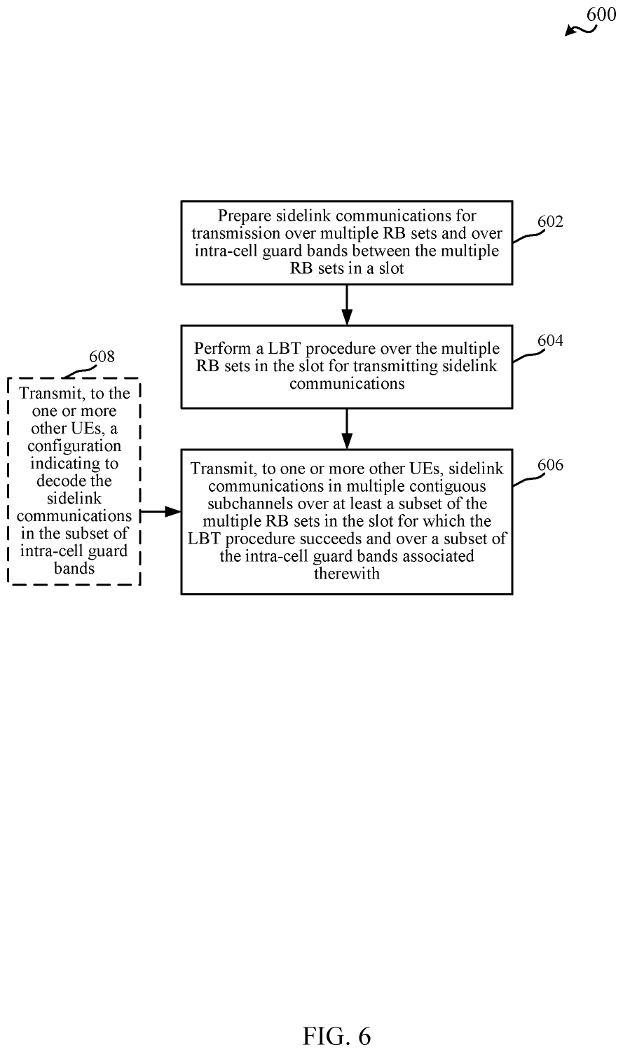

FIG. 6 illustrates a flow chart of an example of a method 600 for transmitting SL communications over a wideband resource allocation that includes multiple RB sets and intra-cell guard bands. In an example, a UE (e.g., UE 104-a, as a SL transmitting UE in sidelink communications) can perform the functions described in method 600 using one or more of the components described in FIGS. 1 and 2.

In method 600, at Block 602 (e.g., for transmitting SL UE 104-a), SL communications can be prepared for transmission over multiple RB sets and over intra-cell guard bands between the multiple RB sets in a slot. In an aspect, communication preparing component 252, e.g., in conjunction with processor(s) 212, memory 216, transceiver 202, communicating component 242, etc., can prepare SL communications for transmission over multiple RB sets and over intra-cell guard bands between the multiple RB sets in the slot. In one example, communication preparing component 252 can prepare the SL communications for transmitting in SL Mode 2, where the base station 102 may indicate a resource allocation pool for the transmitting SL UE, and the transmitting SL UE can select resources for transmitting the SL communications. As such, for example, communication preparing component 252 can select RB sets from the resource allocation pool along with the intra-cell guard bands for transmitting SL communications to one or more receiving SL UEs. Where communication preparing component 252 prepares SL communications for transmitting in RB sets that are separated by an intra-cell guard band, communication preparing component 252 can determine also use the intra-cell guard band for the SL communications.

In method 600, at Block 604 (e.g., for transmitting SL UE 104-a), an LBT procedure can be performed over the multiple RB sets in the slot for transmitting SL communications. In an aspect, LBT component 256, e.g., in conjunction with processor(s) 212, memory 216, transceiver 202, communicating component 242, etc., can perform the LBT procedure over the multiple RB sets in the slot for transmitting SL communications. For example, LBT component 256 can perform the LBT procedure over each of the multiple RB sets to determine which RB sets have a clear channel for transmitting SL communications to one or more receiving SL UEs.

In method 600, at Block 606 (e.g., for transmitting SL UE 104-a), SL communications can be transmitted, to one or more other UEs, in the multiple contiguous subchannels across at least a subset of the multiple RB sets in the slot for which the LBT procedure succeeds and over a subset of the intra-cell guard bands associated therewith. In an aspect, communicating component 242, e.g., in conjunction with processor(s) 212, memory 216, transceiver 202, etc., can transmit, to one or more other UEs (e.g., one or more receiving SL UEs 104-b), SL communications in the multiple contiguous subchannels across at least a subset of the multiple RB sets in the slot for which the LBT procedure succeeds and over a subset of the intra-cell guard bands associated therewith. Communicating component 242 may refrain from transmitting SL communicates in one or more of the multiple RB sets for which the LBT procedure fails or otherwise does not succeed, which may indicate that these one or more RB sets are occupied for communications by another device. In any case, for example, communicating component 242 can additionally utilize the intra-cell guard bands for transmitting SL communications where the intra-cell guard bands separate RB sets for which LBT succeeds.

In an example, in method 600, optionally at Block 608, a configuration indicating to decode the SL communications in the subset of intra-cell guard bands can be transmitted to the one or more UEs. In an aspect, communicating component 242, e.g., in conjunction with processor(s) 212, memory 216, transceiver 202, etc., can transmit, to the one or more other UEs (e.g., one or more receiving SL UEs 104-b), the configuration indicating to decode the sidelink communications in the subset of intra-cell guard bands. For example, the configuration can be a RRC or other L3 configuration, or may be configured or activated in SCI or by MAC-CE, etc.

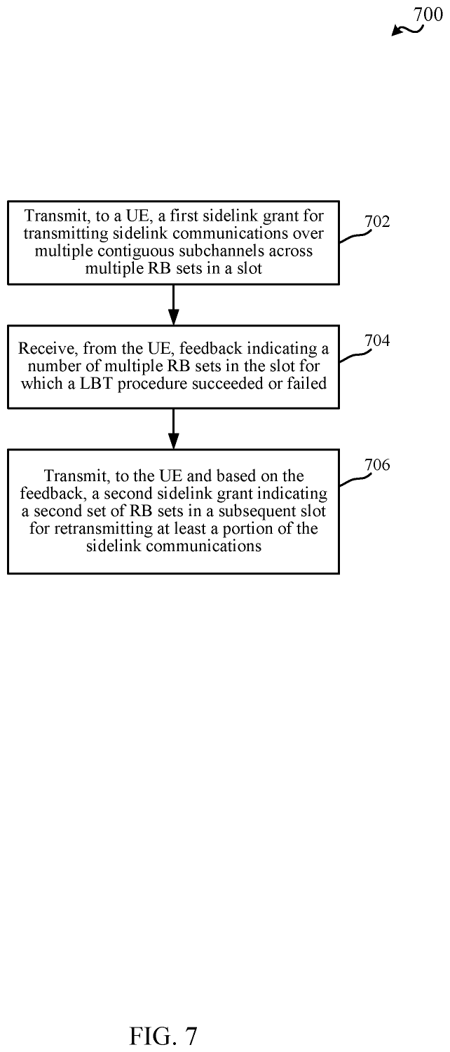

FIG. 7 illustrates a flow chart of an example of a method 700 for transmitting SL grants for a UE, including a SL grant for retransmissions. In an example, a base station 102 can perform the functions described in method 400 using one or more of the components described in FIGS. 1 and 3.

In method 700, at Block 702, a SL grant for transmitting SL communications over multiple contiguous subchannels across multiple RB sets in a slot can be transmitted to a UE. In an aspect, configuring component 342, e.g., in conjunction with processor(s) 312, memory 316, transceiver 302, etc., can transmit, to a UE, the SL grant for transmitting SL communications over multiple contiguous subchannels across multiple RB sets in the slot. For example, the SL grant can indicate or specify the multiple RB sets in the slot over which SL communications can be transmitted by the SL UE 104. Each RB set can include multiple contiguous subchannels. In an example, the RB sets can be contiguous or non-contiguous in frequency, and/or can have intra-cell guard band between the RB sets, as described above.

In method 700, at Block 704, feedback indicating a number of multiple RB sets in the slot for which a LBT procedure succeeded or failed can be received from the UE. In an aspect, feedback component 352, e.g., in conjunction with processor(s) 312, memory 316, transceiver 302, configuring component 342, etc., can receive, from the UE, feedback indicating a number of multiple RB sets in the slot for which the LBT procedure succeeded or failed. As described, for example, the feedback can include a multiple bit indicator indicating a percentage or ratio of the multiple RB sets for which the LBT procedure succeeded or for which the LBT procedure failed. In another example, the feedback can include a multiple bit indicator including a bit for each RB set of the multiple RB sets indicating whether the LBT procedure succeeded or failed for each RB set. In either case, feedback component 352 can process the feedback to determine a second SL grant of resources for retransmitting the SL communications for which the LBT procedure failed.

In method 700, at Block 706, a second SL grant indicating a second set of RB sets in a subsequent slot for retransmitting at least a portion of the SL communications can be transmitted to the UE and based on the feedback. In an aspect, configuring component 342, e.g., in conjunction with processor(s) 312, memory 316, transceiver 302, etc., can transmit, to the UE and based on the feedback, the second SL grant indicating the second set of RB sets in the subsequent slot for retransmitting at least the portion of the SL communications. For example, the second SL grant can include a number of RB sets sufficient for retransmitting the SL communications for which the LBT procedure failed, an additional number of RB sets to account for failure of LBT in the subsequent slot, etc.

FIG. 15 is a block diagram of a MIMO communication system 1500 including a base station 102 and a UE 104, in accordance with various aspects of the present disclosure. The MIMO communication system 1500 may illustrate aspects of the wireless communication access network 100 described with reference to FIG. 1. The base station 102 may be an example of aspects of the base station 102 described with reference to FIG. 1. In addition, the UE 104 can communicate with another UE over sidelink resources using similar functionality described herein with respect to UE 104 and base station 102 communications, and as such, base station 102 could be another UE 104 having a communicating component 242.

The base station 102 may be equipped with antennas 1534 and 1535, and the UE 104 may be equipped with antennas 1552 and 1553. In the MIMO communication system 1500, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 1520 may receive data from a data source. The transmit processor 1520 may process the data. The transmit processor 1520 may also generate control symbols or reference symbols. A transmit MIMO processor 1530 may perform spatial processing (e.g., precoding) on data symbols, control symbols, or reference symbols, if applicable, and may provide output symbol streams to the transmit modulator/demodulators 1532 and 1533. Each modulator/demodulator 1532 through 1533 may process a respective output symbol stream (e.g., for OFDM, etc.) to obtain an output sample stream. Each modulator/demodulator 1532 through 1533 may further process (e.g., convert to analog, amplify, filter, and upconvert) the output sample stream to obtain a DL signal. In one example, DL signals from modulator/demodulators 1532 and 1533 may be transmitted via the antennas 1534 and 1535, respectively.

The UE 104 may be an example of aspects of the UEs 104 described with reference to FIGS. 1-2. At the UE 104, the UE antennas 1552 and 1553 may receive the DL signals from the base station 102 and may provide the received signals to the modulator/demodulators 1554 and 1555, respectively. Each modulator/demodulator 1554 through 1555 may condition (e.g., filter, amplify, downconvert, and digitize) a respective received signal to obtain input samples. Each modulator/demodulator 1554 through 1555 may further process the input samples (e.g., for OFDM, etc.) to obtain received symbols. A MIMO detector 1556 may obtain received symbols from the modulator/demodulators 1554 and 1555, perform MIMO detection on the received symbols, if applicable, and provide detected symbols. A receive (Rx) processor 1558 may process (e.g., demodulate, deinterleave, and decode) the detected symbols, providing decoded data for the UE 104 to a data output, and provide decoded control information to a processor 1580, or memory 1582.

The processor 1580 may in some cases execute stored instructions to instantiate a communicating component 242 (see e.g., FIGS. 1 and 2).

On the uplink (UL), at the UE 104, a transmit processor 1564 may receive and process data from a data source. The transmit processor 1564 may also generate reference symbols for a reference signal. The symbols from the transmit processor 1564 may be precoded by a transmit MIMO processor 1566 if applicable, further processed by the modulator/demodulators 1554 and 1555 (e.g., for SC-FDMA, etc.), and be transmitted to the base station 102 in accordance with the communication parameters received from the base station 102. At the base station 102, the UL signals from the UE 104 may be received by the antennas 1534 and 1535, processed by the modulator/demodulators 1532 and 1533, detected by a MIMO detector 1536 if applicable, and further processed by a receive processor 1538. The receive processor 1538 may provide decoded data to a data output and to the processor 1540 or memory 1542.

The processor 1540 may in some cases execute stored instructions to instantiate a configuring component 342 (see e.g., FIGS. 1 and 3).

The components of the UE 104 may, individually or collectively, be implemented with one or more application specific integrated circuits (ASICs) adapted to perform some or all of the applicable functions in hardware. Each of the noted modules may be a means for performing one or more functions related to operation of the MIMO communication system 1500. Similarly, the components of the base station 102 may, individually or collectively, be implemented with one or more ASICs adapted to perform some or all of the applicable functions in hardware. Each of the noted components may be a means for performing one or more functions related to operation of the MIMO communication system 1500.

The following aspects are illustrative only and aspects thereof may be combined with aspects of other embodiments or teaching described herein, without limitation.

Aspect 1 is a method for wireless communications by a UE including receiving, by the UE and from a base station, a sidelink grant for transmitting sidelink communications over multiple contiguous subchannels across multiple RB sets in a slot, performing, by the UE, a LBT procedure over the multiple RB sets in the slot, and transmitting, by the UE and to one or more other UEs, sidelink communications in the multiple contiguous subchannels across at least a subset of the multiple RB sets in the slot for which the LBT procedure succeeds.

In Aspect 2, the method of Aspect 1 includes where transmitting the sidelink communications includes transmitting each transport block of multiple transport blocks over one of the subset of the multiple RB sets.

In Aspect 3, the method of Aspect 2 includes where each transport block includes a physical sidelink control channel and a physical sidelink shared channel transmitted in the multiple contiguous subchannels of the one of the subset of the multiple RB sets.

In Aspect 4, the method of any of Aspects 2 or 3 includes preparing, based on the sidelink grant, a set of transport blocks, including the multiple transmit blocks, for transmission over the multiple RB sets, and where transmitting each transport block includes selecting the multiple transmit blocks from the set of transport blocks based on the subset of RB sets for which the LBT procedure succeeds.

In Aspect 5, the method of any of Aspects 2 to 4 includes where the sidelink grant indicates multiple retransmission RB sets in a subsequent slot for retransmitting the sidelink communications, and where each transport block includes a physical sidelink control channel that indicates a corresponding one of the multiple retransmission RB sets in the subsequent slot for retransmitting the sidelink communications.

In Aspect 6, the method of any of Aspects 2 to 5 includes where the sidelink grant indicates multiple retransmission RB sets in a subsequent slot for retransmitting the sidelink communications, and where each transport block includes a physical sidelink control channel that indicates the multiple retransmission RB sets in the subsequent slot for retransmitting the sidelink communications.

In Aspect 7, the method of Aspect 1 includes where transmitting the sidelink communications includes transmitting each CBG transmission of multiple FDM CBG transmissions over the multiple contiguous subchannels of one of the subset of the multiple RB sets.

In Aspect 8, the method of Aspect 7 includes where each CBG transmission includes a physical sidelink control channel, having a distributed sidelink control information, and a physical sidelink shared channel transmitted in the multiple contiguous subchannels of the one of the subset of the multiple RB sets.

In Aspect 9, the method of Aspect 8 includes where the physical sidelink control channel is included in a leading subchannel of the multiple contiguous subchannels of each of the subset of the multiple RB sets.

In Aspect 10, the method of any of Aspects 8 or 9 includes where the distributed sidelink control information indicates each of the multiple FDM CBG transmissions.

In Aspect 11, the method of any of Aspects 8 to 10 includes preparing, based on the sidelink grant, a set of multiple sidelink control information corresponding to each of a set of FDM CBG transmissions, and preparing the distributed sidelink control information to include a subset of the set of multiple sidelink control information based on the subset of RB sets for which the LBT procedure succeeds, where transmitting each CBG transmission includes selecting the multiple FDM CBG transmissions from the set of FDM CBG transmissions based on the subset of RB sets for which the LBT procedure succeeds.

In Aspect 12, the method of Aspect 11 includes where the distributed sidelink control information indicates resources of each of the subset of RB sets that is reserved for distributed sidelink control information.

In Aspect 13, the method of any of Aspects 11 or 12 includes where the sidelink grant indicates multiple retransmission RB sets in a subsequent slot for retransmitting the sidelink communications, and where the distributed sidelink control information indicates the multiple retransmission RB sets in the subsequent slot for retransmitting the sidelink communications.

In Aspect 14, the method of Aspect 13 includes where the distributed sidelink control information includes a multiple-bit CBG indicator that indicates, for each of the multiple RB sets, whether the LBT procedure succeeded.

In Aspect 15, the method of any of Aspects 1 to 14 includes transmitting, to the base station, feedback for requesting resources for retransmitting the sidelink communications, where the feedback indicates an amount of RB sets in the subset of the multiple RB sets used for transmitting sidelink communications.

In Aspect 16, the method of Aspect 15 includes where the amount of RB sets is indicated as an approximate ratio of the subset of the multiple RB sets to the multiple RB sets.

In Aspect 17, the method of any of Aspects 1 to 16 includes preparing, based on the sidelink grant, sidelink communications for transmission over the multiple RB sets and over intra-cell guard bands between the multiple RB sets, where transmitting the sidelink communications includes transmitting the sidelink communications over the subset of the multiple RB sets in the slot for which the LBT procedure succeeds and over a subset of the intra-cell guard bands associated with the subset of the multiple RB sets.

In Aspect 18, the method of Aspect 17 includes transmitting, to the one or more other UEs, a configuration indicating to decode the sidelink communications in the subset of intra-cell guard bands.

Aspect 19, the method of Aspect 18 includes where transmitting the configuration includes transmitting a configuration indicating an ability to transmit sidelink communications in intra-cell guard bands and an indicator in sidelink control information indicating whether to decode the sidelink communications in the subset of the intra-cell guard bands.

Aspect 20 is a method for wireless communications by a UE including preparing, by the UE, sidelink communications for transmission over multiple RB sets and over intra-cell guard bands between the multiple RB sets in a slot, performing, by the UE, a LBT procedure over the multiple RB sets in the slot for transmitting sidelink communications, and transmitting, by the UE and to one or more other UEs, sidelink communications in multiple contiguous subchannels over at least a subset of the multiple RB sets in the slot for which the LBT procedure succeeds and over a subset of the intra-cell guard bands associated with the subset of the multiple RB sets.

In Aspect 21, the method of Aspect 20 includes transmitting, to the one or more UEs, a configuration indicating to decode the sidelink communications in the subset of intra-cell guard bands.

Aspect 22, the method of Aspect 21 includes where transmitting the configuration includes transmitting a configuration indicating an ability to transmit sidelink communications in intra-cell guard bands and an indicator in sidelink control information indicating whether to decode the sidelink communications in the subset of the intra-cell guard bands.

Aspect 23 is a method for wireless communications by a UE including receiving, by the UE, sidelink communications from a transmitting UE in multiple contiguous subchannels across multiple RB sets in a slot for which a LBT procedure succeeds for the transmitting UE, decoding sidelink control information in one of the contiguous subchannels present in each of the multiple RB sets to determine whether a sidelink data channel is intended for the UE, and decoding, where the sidelink control information indicates that the sidelink data channel is intended for the UE, the sidelink data channel in one or more of the contiguous subchannels in one or more of the multiple RB sets.

In Aspect 24, the method of Aspect 23 includes where receiving the sidelink communications includes receiving each transport block of multiple transport blocks over one of the subset of the multiple RB sets.

In Aspect 25, the method of Aspect 24 includes where each transport block includes a physical sidelink control channel and a physical sidelink shared channel transmitted in the multiple contiguous subchannels of the one of the subset of the multiple RB sets.

In Aspect 26, the method of any of Aspects 24 or 25 includes where the sidelink grant indicates multiple retransmission RB sets in a subsequent slot for retransmitting the sidelink communications, and where each transport block includes a physical sidelink control channel that indicates a corresponding one of the multiple retransmission RB sets in the subsequent slot for retransmitting the sidelink communications.

In Aspect 27, the method of Aspect 26 includes receiving, from the transmitting UE, a retransmission of the sidelink data channel over a corresponding retransmission RB set indicated in the multiple retransmission RB sets.

In Aspect 28, the method of any of Aspects 24 to 27 includes where the sidelink grant indicates multiple retransmission RB sets in a subsequent slot for retransmitting the sidelink communications, and where each transport block includes a physical sidelink control channel that indicates the multiple retransmission RB sets in the subsequent slot for retransmitting the sidelink communications.

In Aspect 29, the method of Aspect 28 includes receiving, from the transmitting UE, a retransmission of the sidelink communications over the multiple retransmission RB sets, decoding retransmission sidelink control information in one of the contiguous subchannels in each of the multiple retransmission RB sets to determine whether a retransmission sidelink data channel is intended for the UE, and decoding, where the retransmission sidelink control information indicates that the retransmission sidelink data channel is intended for the UE, the retransmission sidelink data channel in one or more of the contiguous subchannels in one or more of the multiple retransmission RB sets.

In Aspect 30, the method of Aspect 23 includes where receiving the sidelink communications includes receiving each CBG transmission of multiple FDM CBG transmissions over one of the subset of the multiple RB sets.

In Aspect 31, the method of Aspect 30 includes where each CBG transmission includes a physical sidelink control channel, having the sidelink control information as distributed sidelink control information distributed in each RB set in the subset of the multiple RB sets, and a physical sidelink shared channel transmitted in multiple contiguous subchannels of the one of the subset of the multiple RB sets.

In Aspect 32, the method of Aspect 31 includes where the physical sidelink control channel is included in a leading subchannel of the multiple contiguous subchannels of each of the subset of the multiple RB sets.

In Aspect 33, the method of any of Aspects 31 or 32 includes where the distributed sidelink control information indicates each of the multiple FDM CBG transmissions.

In Aspect 34, the method of any of Aspects 31 to 33 includes where the distributed sidelink control information indicates resources of each of the subset of RB sets that is reserved for distributed sidelink control information.

In Aspect 35, the method of any of Aspects 31 to 34 includes where the distributed sidelink control information indicates multiple retransmission RB sets in a subsequent slot for retransmitting the sidelink communications.

In Aspect 36, the method of Aspect 35 includes receiving, from the transmitting UE, a retransmission of the sidelink communications over the multiple retransmission RB sets, decoding retransmission sidelink control information in one of the contiguous subchannels in each of the multiple retransmission RB sets to determine whether a retransmission sidelink data channel in the multiple retransmission RB sets is intended for the UE, and decoding, where the retransmission sidelink control information indicates that the retransmission sidelink data channel is intended for the UE, the retransmission sidelink data channel in one or more of the contiguous subchannels in one or more of the multiple retransmission RB sets.

In Aspect 37, the method of Aspect 36 includes where the distributed sidelink control information includes a multiple-bit CBG indicator that indicates, for each of the multiple RB sets, whether the LBT procedure succeeded, and further comprising determining the multiple retransmission RB sets based on the multiple-bit CBG indicator.

In Aspect 38, the method of any of Aspects 23 to 37 includes where receiving the sidelink communications includes receiving the sidelink communications over the subset of the multiple RB sets in the slot for which the LBT procedure succeeds and over a subset of the intra-cell guard bands associated with the subset of the multiple RB sets.

In Aspect 39, the method of Aspect 38 includes receiving, from the transmitting UE, a configuration indicating to decode the sidelink communications in the subset of intra-cell guard bands.

In Aspect 40, the method of Aspect 39 includes where receiving the configuration includes transmitting a configuration receiving an indication of an ability to transmit sidelink communications in intra-cell guard bands from the UE, and an indicator in sidelink control information indicating whether to decode the sidelink communications in the subset of intra-cell guard bands.

Aspect 41 is a method for wireless communication by a base station including transmitting, to a UE, a first sidelink grant for transmitting sidelink communications over multiple contiguous subchannels across multiple RB sets in a slot, receiving, from the UE, feedback indicating a number of the multiple RB sets in the slot for which a LBT procedure succeeded or failed, transmitting, to the UE and based on the feedback, a second sidelink grant indicating a second set of RB sets in a subsequent slot for retransmitting at least a portion of the sidelink communications.

In Aspect 42, the method of Aspect 41 includes where the feedback is a multiple bit indicator specifying a percentage of the multiple RB sets for which the LBT procedure succeeded or failed.

In Aspect 43, the method of Aspect 41 includes where the feedback is a multiple bit indicator including a bit for each RB set of the multiple RB sets indicating whether the LBT procedure succeeded or failed.

Aspect 44 is an apparatus for wireless communication including a transceiver, a memory configured to store instructions, and one or more processors communicatively coupled with the transceiver and the memory, where the one or more processors are configured to execute the instructions to perform the operations of one or more methods in any of Aspects 1 to 43.

Aspect 45 is an apparatus for wireless communication including means for performing the operations of one or more methods in any of Aspects 1 to 43.

Aspect 46 is a computer-readable medium including code executable by one or more processors to perform the operations of one or more methods in any of Aspects 1 to 43.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, hardwiring, or combinations of any of these. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. Also, as used herein, including in the claims, “or” as used in a list of items prefaced by “at least one of” indicates a disjunctive list such that, for example, a list of “at least one of A, B, or C” means A or B or C or AB or AC or BC or ABC (A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
a memory configured to store instructions; and
one or more processors communicatively coupled with the memory and the transceiver, wherein the one or more processors are configured to execute the instructions to cause the apparatus to:
receive, from a base station, a sidelink grant for transmitting sidelink communications over multiple contiguous subchannels across multiple resource block (RB) sets in a slot;
perform a listen-before-talk (LBT) procedure over the multiple RB sets in the slot; and
transmit, to one or more other UEs, sidelink communications in the multiple contiguous subchannels across at least a subset of the multiple RB sets in the slot for which the LBT procedure succeeds.

2. The apparatus of claim 1, wherein the one or more processors are configured to execute the instructions to cause the apparatus to transmit the sidelink communications at least in part by transmitting each transport block of multiple transport blocks over one of the subset of the multiple RB sets.

3. The apparatus of claim 2, wherein each transport block includes a physical sidelink control channel and a physical sidelink shared channel transmitted in the multiple contiguous subchannels of the one of the subset of the multiple RB sets.

4. The apparatus of claim 2, wherein the one or more processors are further configured to execute the instructions to cause the apparatus to prepare, based on the sidelink grant, a set of transport blocks, including the multiple transmit blocks, for transmission over the multiple RB sets, and wherein the one or more processors are configured to execute the instructions to cause the apparatus to transmit each transport block at least in part by selecting the multiple transmit blocks from the set of transport blocks based on the subset of RB sets for which the LBT procedure succeeds.

5. The apparatus of claim 2, wherein the sidelink grant indicates multiple retransmission RB sets in a subsequent slot for retransmitting the sidelink communications, and wherein each transport block includes a physical sidelink control channel that indicates a corresponding one of the multiple retransmission RB sets in the subsequent slot for retransmitting the sidelink communications.

6. The apparatus of claim 2, wherein the sidelink grant indicates multiple retransmission RB sets in a subsequent slot for retransmitting the sidelink communications, and wherein each transport block includes a physical sidelink control channel that indicates the multiple retransmission RB sets in the subsequent slot for retransmitting the sidelink communications.

7. The apparatus of claim 1, wherein the one or more processors are configured to execute the instructions to cause the apparatus to transmit the sidelink communications at least in part by transmitting each code block group (CBG) transmission of multiple frequency division multiplexed (FDM) CBG transmissions over the multiple contiguous subchannels of one of the subset of the multiple RB sets.

8. The apparatus of claim 7, wherein each CBG transmission includes a physical sidelink control channel, having a distributed sidelink control information, and a physical sidelink shared channel transmitted in the multiple contiguous subchannels of the one of the subset of the multiple RB sets.

9. The apparatus of claim 8, wherein the physical sidelink control channel is included in a leading subchannel of the multiple contiguous subchannels of each of the subset of the multiple RB sets.

10. The apparatus of claim 8, wherein the distributed sidelink control information indicates each of the multiple FDM CBG transmissions.

11. The apparatus of claim 8, wherein the one or more processors are further configured to execute the instructions to cause the apparatus to:
prepare, based on the sidelink grant, a set of multiple sidelink control information corresponding to each of a set of FDM CBG transmissions; and
prepare the distributed sidelink control information to include a subset of the set of multiple sidelink control information based on the subset of RB sets for which the LBT procedure succeeds,
wherein the one or more processors are configured to execute the instructions to cause the apparatus to transmit each CBG transmission at least in part by selecting the multiple FDM CBG transmissions from the set of FDM CBG transmissions based on the subset of RB sets for which the LBT procedure succeeds.

12. The apparatus of claim 11, wherein the distributed sidelink control information indicates resources of each of the subset of RB sets that is reserved for distributed sidelink control information.

13. The apparatus of claim 11, wherein the sidelink grant indicates multiple retransmission RB sets in a subsequent slot for retransmitting the sidelink communications, and wherein the distributed sidelink control information indicates the multiple retransmission RB sets in the subsequent slot for retransmitting the sidelink communications.

14. The apparatus of claim 13, wherein the distributed sidelink control information includes a multiple-bit CBG indicator that indicates, for each of the multiple RB sets, whether the LBT procedure succeeded.

15. The apparatus of claim 1, wherein the one or more processors are further configured to execute the instructions to cause the apparatus to transmit, to the base station, feedback for requesting resources for retransmitting the sidelink communications, wherein the feedback indicates an amount of RB sets in the subset of the multiple RB sets used for transmitting sidelink communications.

16. The apparatus of claim 15, wherein the amount of RB sets is indicated as an approximate ratio of the subset of the multiple RB sets to the multiple RB sets.

17. The apparatus of claim 1, wherein the one or more processors are further configured to execute the instructions to cause the apparatus to prepare, based on the sidelink grant, sidelink communications for transmission over the multiple RB sets and over intra-cell guard bands between the multiple RB sets, wherein the one or more processors are configured to execute the instructions to cause the apparatus to transmit the sidelink communications over the subset of the multiple RB sets in the slot for which the LBT procedure succeeds and over a subset of the intra-cell guard bands associated with the subset of the multiple RB sets.

18. The apparatus of claim 17, wherein the one or more processors are further configured to execute the instructions to cause the apparatus to transmit, to the one or more other UEs, a configuration indicating to decode the sidelink communications in the subset of intra-cell guard bands.

19. The apparatus of claim 18, wherein the one or more processors are configured to execute the instructions to cause the apparatus to transmit the configuration indicating an ability to transmit sidelink communications in intra-cell guard bands and an indicator in sidelink control information indicating whether to decode the sidelink communications in the subset of the intra-cell guard bands.

20. An apparatus for wireless communication, comprising:
a transceiver;
a memory configured to store instructions; and
one or more processors communicatively coupled with the memory and the transceiver, wherein the one or more processors are configured to execute the instructions to cause the apparatus to:
receive sidelink communications from a transmitting UE in multiple contiguous subchannels across multiple resource block (RB) sets in a slot for which a listen-before-talk (LBT) procedure succeeds for the transmitting UE;
decode sidelink control information in one of the contiguous subchannels present in each of the multiple RB sets to determine whether a sidelink data channel is intended for the apparatus; and
decode, where the sidelink control information indicates that the sidelink data channel is intended for the apparatus, the sidelink data channel in one or more of the contiguous subchannels in one or more of the multiple RB sets.

21. The apparatus of claim 20, wherein the one or more processors are configured to execute the instructions to cause the apparatus to receive the sidelink communications at least in part by receiving each transport block of multiple transport blocks over one of at least a subset of the multiple RB sets.

22. The apparatus of claim 21, wherein each transport block includes a physical sidelink control channel and a physical sidelink shared channel transmitted in the multiple contiguous subchannels of the one of the subset of the multiple RB sets.

23. The apparatus of claim 20, wherein the one or more processors are configured to execute the instructions to cause the apparatus to receive the sidelink communications at least in part by receiving each code block group (CBG) transmission of multiple frequency division multiplexed (FDM) CBG transmissions over one of at least a subset of the multiple RB sets.

24. The apparatus of claim 23, wherein each CBG transmission includes a physical sidelink control channel, having the sidelink control information as distributed sidelink control information distributed in each RB set in the subset of the multiple RB sets, and a physical sidelink shared channel transmitted in multiple contiguous subchannels of the one of the subset of the multiple RB sets.

25. The apparatus of claim 24, wherein the distributed sidelink control information indicates each of the multiple FDM CBG transmissions.

26. The apparatus of claim 24, wherein the distributed sidelink control information indicates resources of each of the subset of RB sets that is reserved for distributed sidelink control information.

27. A method for wireless communications by a user equipment (UE), comprising:
receiving, by the UE and from a base station, a sidelink grant for transmitting sidelink communications over multiple contiguous subchannels across multiple resource block (RB) sets in a slot;
performing, by the UE, a listen-before-talk (LBT) procedure over the multiple RB sets in the slot; and
transmitting, by the UE and to one or more other UEs, sidelink communications in the multiple contiguous subchannels across at least a subset of the multiple RB sets in the slot for which the LBT procedure succeeds.

28. The method of claim 27, wherein transmitting the sidelink communications includes transmitting each transport block of multiple transport blocks over one of the subset of the multiple RB sets.

29. A method for wireless communications by a user equipment (UE), comprising:
receiving, by the UE, sidelink communications from a transmitting UE in multiple contiguous subchannels across multiple resource block (RB) sets in a slot for which a listen-before-talk (LBT) procedure succeeds for the transmitting UE;
decoding sidelink control information in one of the contiguous subchannels present in each of the multiple RB sets to determine whether a sidelink data channel is intended for the UE; and
decoding, where the sidelink control information indicates that the sidelink data channel is intended for the UE, the sidelink data channel in one or more of the contiguous subchannels in one or more of the multiple RB sets.

30. The method of claim 29, wherein receiving the sidelink communications includes receiving each transport block of multiple transport blocks over one of at least a subset of the multiple RB sets.
